(19) United States
(12) Patent Application Publication
(10) Pub. No.: US 2004/0139170 A1
(43) Pub. Date: Jul. 15, 2004

(54) Method and apparatus for management of shared wide area network connections

(76) Inventors: Ming-Teh Shen, Irvine, CA (US); Duong D. Nguyen, Westminster, CA (US); Ken Y. Huang, Irvine, CA (US); Junfeng Wu, Tustin, CA (US)

Correspondence Address: Jack I. J'maev, 11800 Central Avenue, CHINO, CA, 91710, US

(21) Appl. No.: 10/346,572

(22) Filed: Jan. 15, 2003

(51) Int. Cl. G06F 15/16

(52) U.S. Cl. 709/218; 709/245; 709/227

(57) ABSTRACT

Method and apparatus supports subscriber oriented management of shared wide area network connections. Web page requests received from local area network redirected to designated server in case connection to wide area network is not available, or more than one user or more than allowable number of users attempt simultaneous access.

### FIELD OF THE INVENTION

This invention relates generally to customer premises equipment, i.e. access devices that may be used for connection to wide area networks.

### BACKGROUND OF THE INVENTION

With every passing day, the world becomes more “connected”. In even the most remote reaches of the globe, individuals and organizations are connecting their facilities to a wide area network (WAN). One of the most popular wide area networks today is the Internet. By connecting to a WAN, individuals and organizations gain immediate access to information and electronic mail systems. Connecting to a WAN, such as the Internet, provides other benefits such as low cost communications; Voice over IP, applications sharing and multi-party conferencing are some examples of these.

Connecting remote sites to a WAN, such as the Internet, has traditionally been the business focus of companies referred to as “Internet service providers”, or ISPs. An ISP derives revenue by selling connections to a WAN, such as the Internet. About a decade ago, ISPs serviced subscribers by providing a bank of modulator/demodulators (modems) at a central facility. Connections to the WAN, in that era, were temporary. When a subscriber needed to connect to the WAN, the subscriber was required to initiate a modem connection from their remote facility to the central modem bank provided by the ISP.

These modem connections provided very little bandwidth relative to today's standards. To illustrate, the dial-up modem that a typical subscriber may have used to connect to the ISP modem bank would typically operate at 28.8 kilobits per second (kbps). Over time, modems became more efficient. Today, dial-up modems can operate at 56.6 kbps. Although modems may operate at 56.6 kbps, their effectiveness is often limited by the quality of the physical telephone connection a subscriber must use to connect to the modem bank provided by the ISP. Today, digital subscriber line (DSL) modems provide bandwidth of up to 50 times or more than that provided by traditional dial-up modems. Cable modems also provide high-speed access and are now in wide spread use. And, as networking technologies continue to evolve, the speed at which WAN access occurs will doubtlessly continue to rise.

That portion of the Internet known as the world-wide-web (www) is used to store “web pages”. Web pages are files that typically define a textual and graphic image that may be displayed on a computer screen. These web pages may be authored in a page description language. One example of such a page description language is the so-called “hypertext markup language” (HTML). Other markup languages are often used in the definition of web pages. An HTML web page description typically comprises many text-based descriptions that define the formatting and placement of textual information that may be included in the web page. The HTML web page description may also comprise references to other files, such as graphic images, that are intended to be integrated into the web page ultimately presented to a user.

Many of the web pages accessible through the World Wide Web incorporate complex graphics. Using a traditional dial-up modem that provides limited data bandwidth, it was often frustrating for even a single user to access the WWW. Many users continue to experience frustration because of the amount of time necessary to download these complex web pages using a 28.8K or 56.6K modem.

DSL and cable modems were developed primarily in response to the limited amount of bandwidth that can be provided by a dial-up modem. Today's DSL and cable modems also address the problem of temporary connectivity. Hence, the DSL modems that are available today provide high-speed, continuous connection to the WAN. Cable modems also support “always-on” connections.

In many cases, all of the bandwidth provided by a DSL modem is simply not utilized by a single user connected to the World Wide Web. Because a DSL modem provides upwards of 50 times the bandwidth of a traditional dial-up modem, it quickly became apparent that several users could share a single DSL connection. In order to support this type of connection sharing, modem manufacturers began to integrate routing functionality into DSL modems. Once installed at a subscriber's facility, this type of DSL modem is able to connect to a WAN on one side and is able to connect to several client computers on the other. The several client computers connected to the DSL modem form a local area network (LAN). For the purposes of this disclosure, this type of DSL modem may be thought of as a WAN access device that may be disposed at a subscriber's facility. Such a device typically comprises a WAN interface and a LAN interface. In the vernacular used by telephone companies, the DSL modem may also be referred to as “customer premises equipment” (CPE). Note that a WAN access device is not limited to any particular technology, such as DSL or cable modem, and the scope of the present invention is intended to include all forms of connection technologies. DSL modems comprising such routing functions receive requests for web pages from one or more client computers attached to the LAN. Many DSL modems perform the routing function using a technique called network address translation (NAT). Network address translation typically uses a single Internet protocol (IP) address to connect to the WAN. As requests for web pages arrive at the DSL modem from the local area network, the NAT protocol assigns each request from a particular physical address on the LAN to a particular port number. The requests are then augmented with the assigned port number and propagated to the WAN. When a response is received from the WAN, it bears the port number that was assigned to a particular physical address on the LAN. The NAT protocol may then route the incoming responses according to the port number; directing the response to a particular physical address on the LAN.

All of this connection sharing is a great thing. It promotes effective use of the bandwidth provided by a single DSL connection. There is, however, a significant drawback associated with connection sharing. When more than one user shares a DSL connection, the ISP is not able to derive any additional revenue. This is a significant concern. It may be somewhat acceptable when several users in a single household share a single DSL connection. But the problem is exasperated when several households use a single DSL connection to connect to the Internet. Because the technology to form a LAN has become so simple to apply, neighbors can run connections from house-to-house in order to share a single DSL connection. This type of connection sharing is detrimental to the ISP that would otherwise enjoy additional subscription revenue from each household.

Making matters worse from the standpoint of the ISP is the fact that broadband modems, such as cable or DSL modems, require extensive configuration by a subscriber. This means that once the DSL modem is installed, it must be configured by the subscriber prior to use. Most of the time, the subscriber is able to properly configure the access device. However, in many cases, the subscriber is unable to setup the access device. In this case, the subscriber usually cannot ascertain the status of the access device nor the quality of a connection that may be established with a wide area network. These problems are usually remedied when a subscriber calls the ISP for technical support. These technical inquiries are expensive and a single technical support call can cost more than the ISP can earn from subscription fees over the period of a year.

### SUMMARY OF THE INVENTION

The present invention comprises a method for managing connections from a subscriber's facility. The present method comprises a method for redirecting requests for web pages that may be received from a local area network under certain conditions. According to the present method, one or more client computers may be connected together using a local area network. The computers connected to the local area network may then access the wide area network using an access device. The access device typically comprises customer premises equipment (CPE) that may be disposed at the subscriber's facility. Traditionally, subscribers gained access to a WAN using a modem. According to the present invention, a dial-up modem is one type of CPE that may be used to access the WAN. According to another variation of the method of the present invention, the access device may be a high-speed modem such as a digital subscriber line (DSL) device, a cable modem or other high bandwidth connection. It should be noted that the method of the present invention should not be limited in its application with any particular type of wide area network access device. For instance, the invention may be applied in the case where a gateway is installed and the gateway provides other services such as telecommunications. Gateways may actually be connected to wide area networks by other connection technologies. For instance, T1 subscriber lines and satellite connections are two examples that are not intended to limit the scope of the present invention.

According to one illustrative method of the present invention, connection management may be achieved by controlling the propagation of web page requests from the local area network to the wide area network. This type of functionality may be disposed in an access device. One illustrative method may provide for receiving a web page request from the local area network. An access device may then determine whether a connection to the wide area network is available. A connection may be unavailable for a number of reasons. Some examples include, but are not limited to hardware faults in either the access device or the physical connection circuit or improper configuration of an access device. Where the access device determines that the connection to the wide area network is not available, the access device may redirect the web page request to a local server. Generally, this is accomplished by modifying a URL that comprises the web page request. The modified URL typically refers to a web page stored on a local server. Web page requests are typically forwarded to the wide area network when a viable connection is available. The present method also provides for storing a web page on a local server. Should the wide area network connection be unavailable and a web page request is redirected to the local server, the method of the present invention provides that the local server should retrieve the stored web page and direct it to the local area network in response to the web page request initiated by a client device.

Additional process steps, according to one example method of the present invention, allow for discovering the status of an access device. By providing a control-enabled server that is able to ascertain the status of the access device, a web page request from the local area network may be directed to the control-enabled server when access to the wide area network is unavailable. According to at least one variation of this method, a status web page may be generated in response to the web page request rather than merely retrieving a status page from a static file. Hence, the status web page may represent the most current status that the control-enabled server may be able to ascertain.

According to yet another variation of this method, the control-enabled server may be capable of controlling the configuration of the access device. As such, the control-enabled server may be referenced by a web page request that is redirected in the event a wide area network request in not available.

The method of the present invention acknowledges that a client device that requests a web page may do so in two steps. Typically, a first step is required to resolve a domain name into a physical IP address. This first step is normally accomplished when the client process dispatches a domain name resolution request. According to the present method, an access device may receive a translated address from a remote DNS server. The translated address normally comprises a physical IP address and a time-to-live value. If this translated address were allowed to be directed to the client process making the request, the client process may retain the physical IP address for some period of time. Generally, the client process, which may be a web browser, should be prevented from retaining a physical IP address for an extended period of time. Otherwise, the client process could use the physical IP address in an attempt to access the remote web server in order to retrieve web pages therefrom. In this situation where the client process retains the physical IP address of the remote server, it may circumvent any attempt by the access device to redirect a web page request because, according to the present method, redirection is typically accomplished by modifying the URL. Generally, the client process will defer any request for resolution of a domain name when if finds that it has already received an IP address for that domain name through an earlier domain name resolution request sequence.

The present method provides that when a translated address is received, the time-to-live value of that translated address should be reduced if it exceeds a pre-established threshold. An access device may then direct either the original translated address or the modified address back to the client process that originated the domain name request.

According to yet another example method of the present invention, web page requests received from a local area network may be propagated to a wide area network by providing a capability for receiving a first web page request from a first device attached to the local area network. In order to manage a connection to the wide area network, it may be necessary to prevent subsequent users from attaching to the WAN where a first user has previously begun using the connection.

An access device may follow the method of the present invention by storing the source address of the first addressable device in a current user variable. When a subsequent request for a web page arrives from the local area network, this illustrative method provides that the source address of the subsequent web page request be compared with the address stored in the current user variable. If the comparison is successful, the method of the present invention provides that the web page request may be directed to the WAN. In contrast, an access device may recognize that a subsequent web page request has been initiated by a different user when the source address of the subsequent web page request fails to match the value stored in the current user variable. In such a case, the method of the present invention provides that the subsequent web page request be redirected to a designated server. This is typically accomplished by modifying the URL comprising the subsequent web page request. According to one variation of the present method, a designated server may store a web page and respond to the web page request redirected to the designated server. The response typically comprises a web page file that may be directed to the local area network.

In some cases, it may be advantageous to the overall scheme of managing a connection to a wide area network by allowing a subsequent user to access the WAN once a first user has stopped using the connection for some period of time. In support of this feature, the present method provides for setting a timer when the address of the first addressable device is stored in the current user variable. When a subsequent web page request sourced by a different user arrives at the access device, the present method provides for setting the current user variable to the source address of the subsequent web page request if the timer has expired. Accordingly, the subsequent web page request may then be treated as though it arrived from a first user. This will “lock-out” other users that may wish to access the WAN until the timer again expires.

The method of the present invention also allows for redirecting subsequent web page requests to a password web page that may be stored on a designated server. In such cases, a subsequent user may preempt a WAN connection used by a first user by authenticating a higher level of priority by means of a password. Generally, the server may provide a password web page to the client process that initiated the subsequent web page request. The user may then enter a password into the password web page, which the server may then receive. If the server is able to authenticate the password entered by the user, the method of the present invention provides that the server should issue a password overwrite signal. This example method further provides that the current user variable should be set to the address of the subsequent web page request if the password overwrite signal is active.

An ISP may desire to enable additional users to connect simultaneously to a wide area network. Hence, the method of the present invention provides for managing a wide area network connection by first receiving a maximum user account. This maximum user count may be received by an access device from an account management system that may be used by the ISP to control the number of users that are allowed to simultaneously connect to the WAN, i.e. share the connection.

When a web page request is received from a local area network, one example method provides that the source address of the web page request should correspond to a user record that may be maintained by the access device. The access device may then forward the web page request to the wide area network if the user record corresponding to the source address is found. Otherwise, the method of the present invention provides for creating a new user record if the number of existing user records has not yet reached the maximum number as specified by the maximum user count. If another user record cannot be created, the method provides for redirecting the web page request to a designated server. According to one illustrative method of the present invention, this may be accomplished by modifying the URL comprising the web page request and then directing the modified web page request to the designated server.

The invention also comprises a CPE access device that may be used to connect a local area network to a wide area network. According to one illustrative embodiment of the present invention, the CPE access device comprises a local area network interface, a wide area network interface, a status unit and an address resolution unit. According to this example embodiment, the status device may monitor the availability of a connection to the wide area network and may generate a redirection signal when the access device is not actively connected to a WAN. An access device may not be actively connected to a WAN for a number of reasons, including but not limited to equipment faults, poor quality circuit connections and misconfiguration of the access device itself. The address resolution unit, which may be a DNS proxy, receives web page requests from the local area network and generates an IP address corresponding to a local server that may also comprise the access device. By providing the IP address corresponding to the local server to a client process executing in the LAN space, the CPE access device effectively redirects the web page request to the local server if the redirect signal generated by the status unit is active. Otherwise, the address resolution unit may direct the web page request directly to the WAN. According to one alternative embodiment of the present intention, the CPE access device may further comprise a server that may be used to store a web page. Once a web page request is redirected to the server, the server may respond by directing the web page stored thereon into the LAN space.

Commensurate with the method of the present invention, the CPE access device may further comprise a time-to-live monitor. The time-to-live monitor typically receives a translated domain name that typically comprises an IP address and a time-to-live value. The time-to-live monitor may reduce the time-to-live value comprising the translated domain name if the value received exceeds a preestablished threshold. The time-to-live monitor may then propagate the translated address, in either its original or modified form, to the client process that originally requested domain name resolution.

The CPE access device of the present invention may further comprise a control-enabled server. The address resolution unit may redirect web page requests to the control-enabled server when a connection to a wide area network in not available. According to one example embodiment, the control-enabled server is capable of ascertaining the status of the CPE access device. Typically, the control-enabled server generates a status web page that comprises indicators that reflect the status of the CPE access device and may then provide the status web page to the local area network interface. According to one alternative example embodiment of the present invention, the control-enabled server may be capable of controlling the configuration of the access device. In such case, the control-enabled server may store a configuration web page that comprises various data entry controls that a user may use to control the configuration of the access device. Once the control-enabled server receives configuration data from the configuration web page, it may set the configuration of the CPE access device according to that configuration data.

According to one alternative embodiment of the present invention, the CPE access device may comprise a local area network interface, a wide area network interface, an access manager, a redirection unit and an address resolution unit. This particular example embodiment of the invention provides for redirecting web page requests to a designated server when more than one user attempts to access a wide area network.

The access manager of the present invention typically receives a first web page request from the local area network interface and extracts a first source address from the web page request. This first source address may then be stored in a current user variable. The access manager may further direct the first web page request to the wide area network interface. As the access manager receives a subsequent web page request, it may extract the source address of the request and forward the extracted address and the subsequent web page request to the redirection unit.

In this example embodiment, the redirection unit may receive the subsequent web page request from the access manager. The redirection unit may modify the URL comprising the subsequent web page request if the extracted address does not match the value stored in the current user variable. The redirection unit typically forwards the subsequent web page request, whether or not it has been modified, to the address resolution unit that may further comprise the CPE access device.

According to one example embodiment, the address resolution unit is, in essence, a DNS proxy. However, the address resolution unit may be embodiment in other forms and a DNS proxy is only one example of an address resolution unit that may comprise the CPE access device according to the present invention. The address resolution unit typically receives the subsequent web page request from the redirection unit and attempts to resolve the URL comprising that request into an IP address. It should be noted that the URL may have been modified by the redirection unit to refer to a designated server if more than one user attempts to access the WAN. Where the address resolution unit is able to resolve the URL comprising the web page request, it may return an IP address to the client process that requested domain name resolution. Otherwise, the address resolution unit merely forwards the domain name request to the wide area network. Typically, a remote DNS server may then attempt to resolve the domain name and return a physical IP address to the client process that originally requested domain name resolution.

In order to provide effective connection management, the CPE access device may allow a subsequent user to preempt a first user where the subsequent user can demonstrate a higher level of priority over the first user. Typically, this is accomplished through the use of the password. Where the subsequent user attempts to access a web page using a WAN connection, the redirection unit may modify the URL comprising the subsequent web page request to refer to a password web page that may be stored on a designated server. The designated server may interact with the password web page in order to retrieve a password from a subsequent user. According to one illustrative embodiment of the present invention, the designated server may issue a password override signal if the password entered by a user can be validated. In such case, the access manager may be capable of storing the source address of the subsequent web page request in the current user variable in response to the password override signal.

The CPE access device of the present invention may further support connection management by allowing an ISP to enable additional users that may be allowed to access the WAN simultaneously. Such support is provided for in an alternative embodiment of the present invention wherein the CPE access device comprises a local area network interface, a wide area network interface and an access manager. The access manager, according to this embodiment of the invention, may receive a maximum user account. This value may be received from an ISP as an indicator of the number of users that the CPE access device should allow to connect to the WAN simultaneously. The access manager may then receive a web page request from the local area network interface. According to this embodiment of the present invention, the access manager maintains a database of users.

Where the access manager discovers a record in the database of users that corresponds to the source address of the web page request, it typically directs the web page requests to the wide area network. In the event the access manager is unable to discover a record in the database that corresponds to the source address of the web page request, it will create a new user record if the number of existing records is less than the maximum user count. If a new user record cannot be created, the access manager may direct the web page request to a designated server. This may be accomplished by allowing a redirection unit, which may further comprise the access manager, to modify the URL comprising the web page request.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The foregoing aspects are better understood from the following detailed description of one embodiment of the invention with reference to the drawings, in which:

FIG. 1 is a flow diagram that depicts one illustrative method according to the present invention for redirecting a web page request to a local server when a connection to a wide area network is not available;

FIG. 2 is a message diagram that depicts one example method for redirecting a web page request received from a web browser when a connection to a wide area network is not available;

FIG. 3 is a flow diagram that depicts one example method for reducing the persistence of a translated address that may be received from a domain name server according to the present invention;

FIGS. 4 and 5 are two parts of a flow diagram that illustrates one possible method according to the present invention for notifying a subscriber that more than one user is attempting to access a wide area network;

FIGS. 6 and 6A comprise a message diagram that depicts one possible process for redirecting web page requests when more than one user attempts to access the wide area network according to the present invention;

FIG. 7 is a flow diagram that depicts one illustrative method for allowing a subsequent user to preempt wide area network access captured by a first user according to the present invention;

FIG. 8 is a flow diagram that illustrates one example method for allowing a variable number of users to share a connection to a wide area network according to the teachings of the present invention;

FIGS. 9 and 9A, collectively, are a message diagram that depicts one possible process for redirecting web pages when more than a maximum number of users attempt to access the wide area network;

FIG. 10 is a flow diagram that illustrates one possible method for presenting the status and/or the configuration of an access device to a user according to the present invention;

FIG. 11 is a flow diagram that depicts one illustrative method according to the present invention for controlling the configuration of an access device;

FIG. 12 is a block diagram that depicts one example internal structure for an access device according to the present invention;

FIG. 13 is a data flow diagram that represents one possible embodiment of an access device that redirects web page requests to a local server when access to a wide area network is not available;

FIG. 14 is a flow diagram that illustrates one possible embodiment of an access device that redirects web page requests from a local area network when more than one user attempts to access a wide area network;

FIG. 15 is a flow diagram that depicts one example internal structure of an access unit that redirects web page request according to the present invention when more than a maximum number of users attempt to access a wide area network;

FIG. 16 is a pictorial representation of one possible format for a status web page that may be generated by the access device in response to a web page request referencing said status web page; and

FIG. 17 is a pictorial representation of one example format of a configuration web page that may be used to configure an access device according to the present invention.

The components in the figures are not necessarily to scale, emphasis instead being placed upon illustrating the principles of the invention. In the figures, like reference numerals designate corresponding parts throughout the different views.

### DETAILED DESCRIPTION OF THE INVENTION

In order for an ISP to enjoy the benefit of additional revenue as a plurality of client computers are attached to a LAN, it becomes necessary to provide some form of connection management at a subscriber's facility. The present invention provides a method for such connection management. Further, the present invention provides a method for notifying a subscriber that connection management is necessary. The method of the present invention is generally applicable in the context of one or more computers attached to a LAN interface comprising a WAN access device. The WAN access device typically comprises separate WAN interface for attaching to a WAN. It should be noted that the method of the present invention is not intended to be limited for use in this one example application.

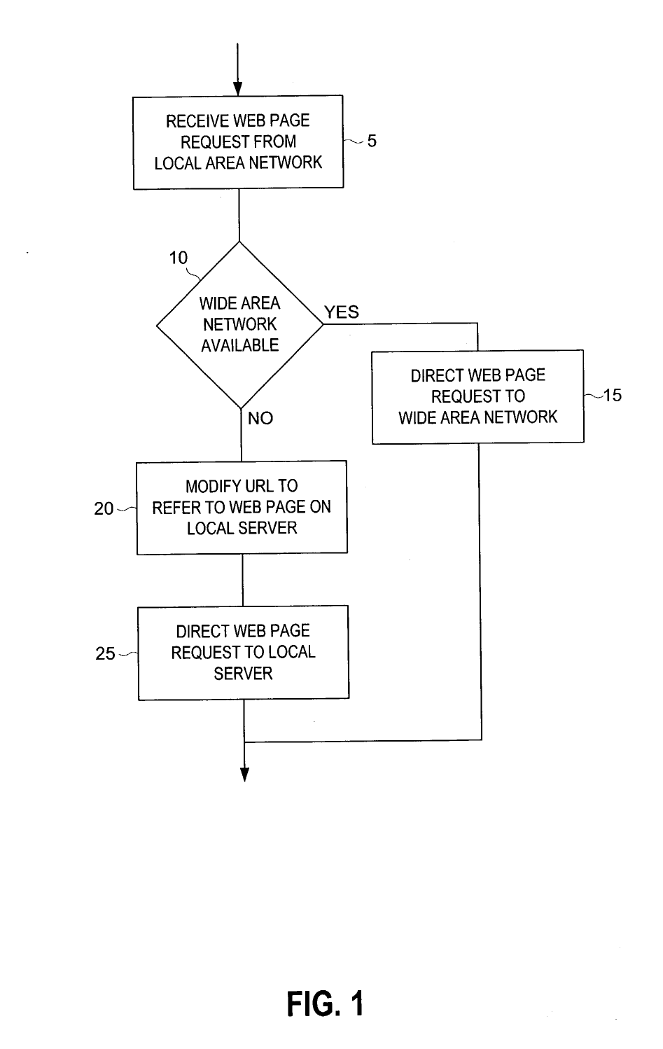

FIG. 1 is a flow diagram that depicts one illustrative method according to the present invention for redirecting a web page request to a local server when a connection to a wide area network is not available. One form of connection management provides for notifying a subscriber that the connection used by the subscriber to access the wide area network is not available. The unavailability may be due in part to a malfunctioning access device or it may be due to poor quality in the communications channel used to connect the subscriber's facility to the WAN. A connection to the wide area network may be unavailable for a number of other reasons. One instance where a connection may not be available may be when a WAN access device is not properly configured either initially or by subsequent user error. These are but a few examples of causes that may contribute to the unavailability of a connection to the WAN and are not intended to limit the scope of the present invention.

According to this illustrative method, an access device may receive a web page request from a local area network (step 5). The present method provides for checking the availability of a connection to the wide area network (step 10). In the case where the connection to the wide area network is available, the web page request may be forwarded directly to the wide area network (step 15).

This example method illustrates that, according to the present invention, the web page request may be redirected to a local server (step 20) if a connection to the WAN is not available. According to one illustrative example of this present method, this may be done by modifying the universal resource locator (URL) reference comprising the web page request. Once the URL is modified, the web page request may then be redirected to the local server (step 25).

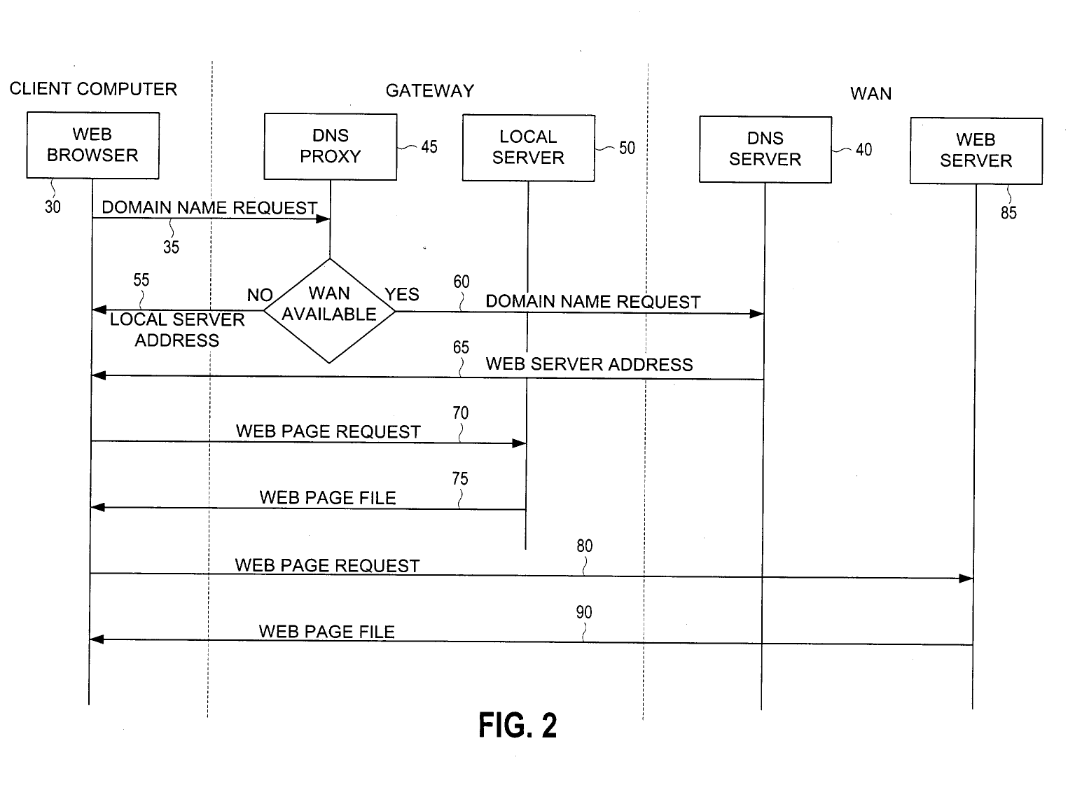

FIG. 2 is a message diagram that depicts one example method for redirecting a web page request received from a web browser when a connection to a wide area network is not available. As already illustrated, the request for a web page may be directed according to the method of the present invention to a local server when a connection to a wide area network is not available. According to one variation of this method, a web page request may be received from a browser 30. The browser 30 may comprise a software module that may be executed on a client computer and that is capable of interpreting a markup language typically used to describe a web page. Once the browser interprets the markup language, it may present a web page to a user.

The browser 30 may receive a URL referencing a web page from a user. According to one variation of this method, the URL received from the user comprises a domain name rather than a physical IP address. In this case, the web browser 30 which executes on the client computer may need to discover the physical IP address of the server on which the requested web page is stored (i.e. “hosted”). This is typically accomplished by dispatching a domain name request (connection 35). Ordinarily, the domain name request (connection 35) would be dispatched to a domain name server (DNS) 40 typically located somewhere out in the WAN space. According to the method of the present invention, an access device may comprise a DNS proxy 45. The method of the present invention provides that the DNS proxy 45 should return an IP address (connection 55) for a local server 50 if the WAN connection is not available. If the WAN connection is available, this variation of the inventive method provides for forwarding the domain name request (connection 60) to the domain name server 40. If the WAN connection is available and the DNS server 40 receives the domain name request, it typically responds with the IP address of the web server (connection 65) that hosts the requested web page.

In the case where the WAN connection is not available, the web browser 30 will receive the address of the local server 50 from the DNS proxy 45. Using this address, the web browser 30 will then dispatch a request for the web page (connection 70) to the local server 50. In response, the local server typically returns a web page file (connection 75). The browser may then present the web page defined by the web page file to the user.

In the case where the WAN connection is available, the browser 30 may use the IP address of the web server provided by the DNS server 40 to request a web page (connection 80) from the web server 85 located in the WAN space. The remote web server 85 may then provide a web page file (connection 90) that may be interpreted by the web browser 30 and presented to the user.

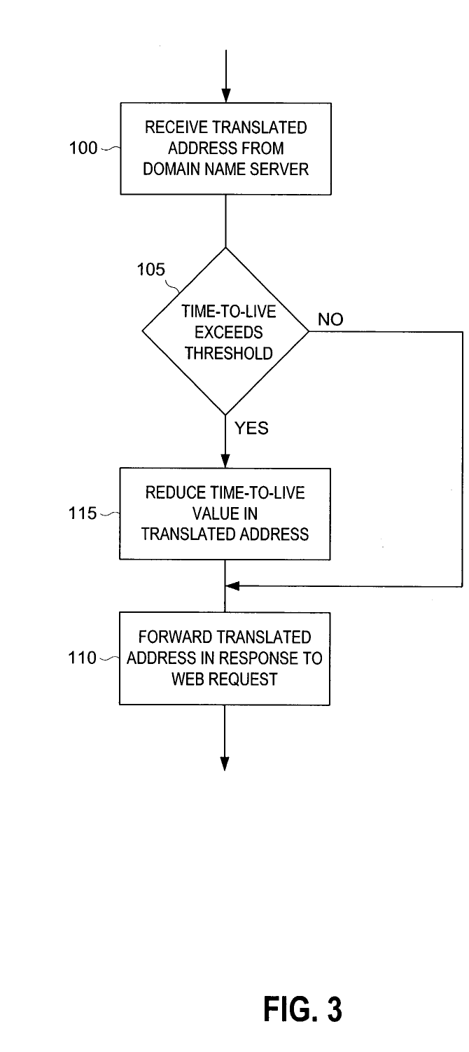

FIG. 3 is a flow diagram that depicts one example method for reducing the persistence of a translated address that may be received from a domain name server according to the present invention. In order to provide effective connection management at the subscriber's facility, it may be necessary to preclude the web browser 30 from retaining translated addresses that it may receive from either a DNS proxy 45 or a DNS server 40 located in the WAN space. According to one illustrative method of the present invention, a WAN access device may receive a translated address from the domain name server (step 100). Typically, the translated address comprises a time-to-live value. The time-to-live value is typically used to express the persistence of a translated address, that is to say the duration for which the translated address is valid.

The method of the present invention provides for comparing the time-to-live value to a threshold (step 105). If the time-to-live value does not exceed a threshold level, the translated address may be forwarded to the web browser in response to its original request for address resolution (step 110). In the event that the time-to-live value exceeds the preestablished threshold, the method of the present invention provides for reducing the time-to-live value (step 115) comprising the translated address. The translated address, as modified, may then be forwarded to the web browser (step 110).

The method of the present invention may further provide for storing a web page on a local server. In this case, the local server, which may further comprise the access device, may then direct the web page to the local area network in order to convey the web page to the requesting web browser executing on a client computer.

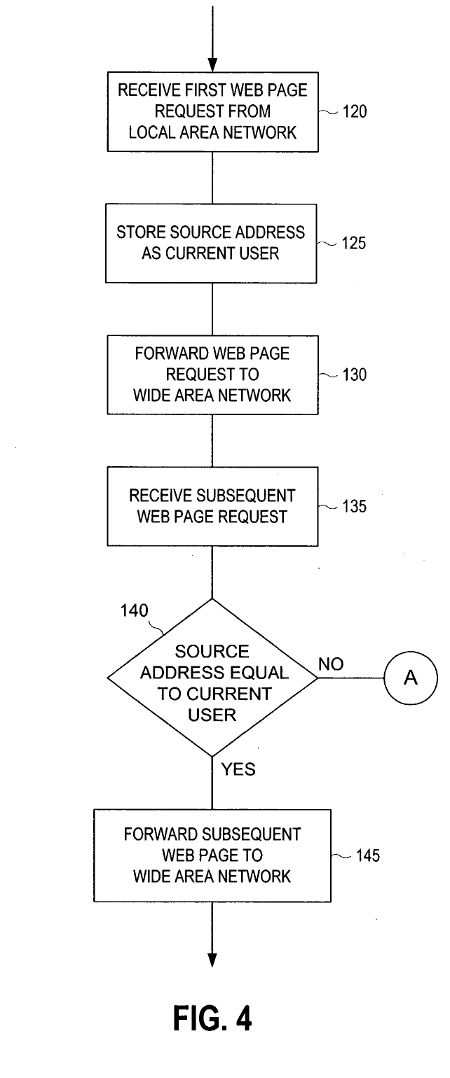

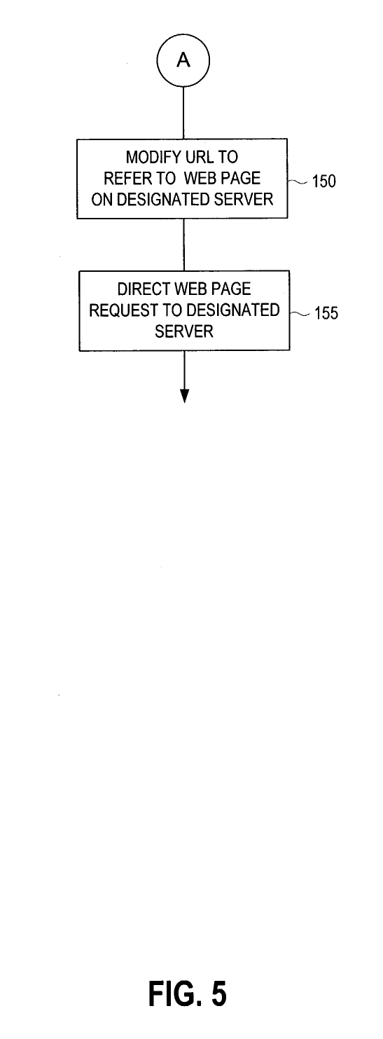

FIGS. 4 and 5 are two parts of a flow diagram that illustrates one possible method according to the present invention for notifying a subscriber that more than one user is attempting to access a wide area network. The method of the present invention may provide connection management by recognizing WAN access by a first user and then notifying subsequent users that WAN access cannot be provided because the WAN is currently in use by the first user.

According to this illustrative method, an access device may receive a first web page request from a first device attached to a local area network (step 120). Typically, this first device is attached to the LAN using a particular IP address peculiar to the LAN address space. According to one variation of this method, the source address of the first web page request may be stored in a variable reflecting a current user (step 125). The method of the present invention further provides for forwarding the first web page request to the wide area network (step 130).

When an additional user attempts to access the wide area network, the subsequent web page request may be received by the access device (step 135). The present method provides for comparing the source address of the subsequent web page request to the value stored in the current user variable (step 140). If the source address of the subsequent web page request is equal to the value stored in the current user variable, the web page request may be forwarded to the WAN (step 145).

If, on the other hand, the source address of the web page request is not equal to the value stored in the current user variable, the web page request may be redirected to a designated server. According to one derivative of the present method, redirecting the web page request to the designated server may be accomplished by modifying the URL comprising the web page request to refer to a web page stored on the designated server (step 150). Once the URL is modified, the web page request may then be directed to the designated server (step 155). It should be noted that the designated server may be attached to the LAN to which the client computer that originally sourced the web page request is attached. The designated server may likewise comprise an access device that may be used to connect the LAN to the wide area network. The designated server may also be attached to the wide area network.

The present method may further provide steps for setting a timer when the address of the first addressable device is stored in the current user variable. When a subsequent web page request is received, its source address may be stored in the current user variable if the timer has expired. This process provides for resetting of the current user variable in cases where a first user has finished using a computer that is attached to the LAN with one particular IP address. After the timer period expires, a subsequent web page request may be received from any other computer attached to the LAN and may then be treated as a web page request from a first user, locking out other subsequent users from accessing the WAN.

According to one variation of the present method, the timer may be implemented by reading a real-time value from a clock. This value may then be stored in a start time variable. This initial value may be stored in the start time variable when the first web page request is received. When a subsequent web page request is received, the method provides for determining if the subsequent web page request was received from the first user by comparing the source address to the value stored in the current user variable. If the comparison is successful, the method of the present invention provides for resetting the timer by updating the value stored in the start time variable with a new value from the clock. When the source address indicates that a different user is attempting to access the WAN, this illustrative method provides for reading a real-time value from the clock and discovering the difference between the current value and that stored in the start time variable. If the difference in time exceeds a pre-established threshold, the process continues by setting the current user variable to the source address of the subsequent web page request. This allows a subsequent user to gain access to the WAN after the first user has stopped using the connection for some period of time.

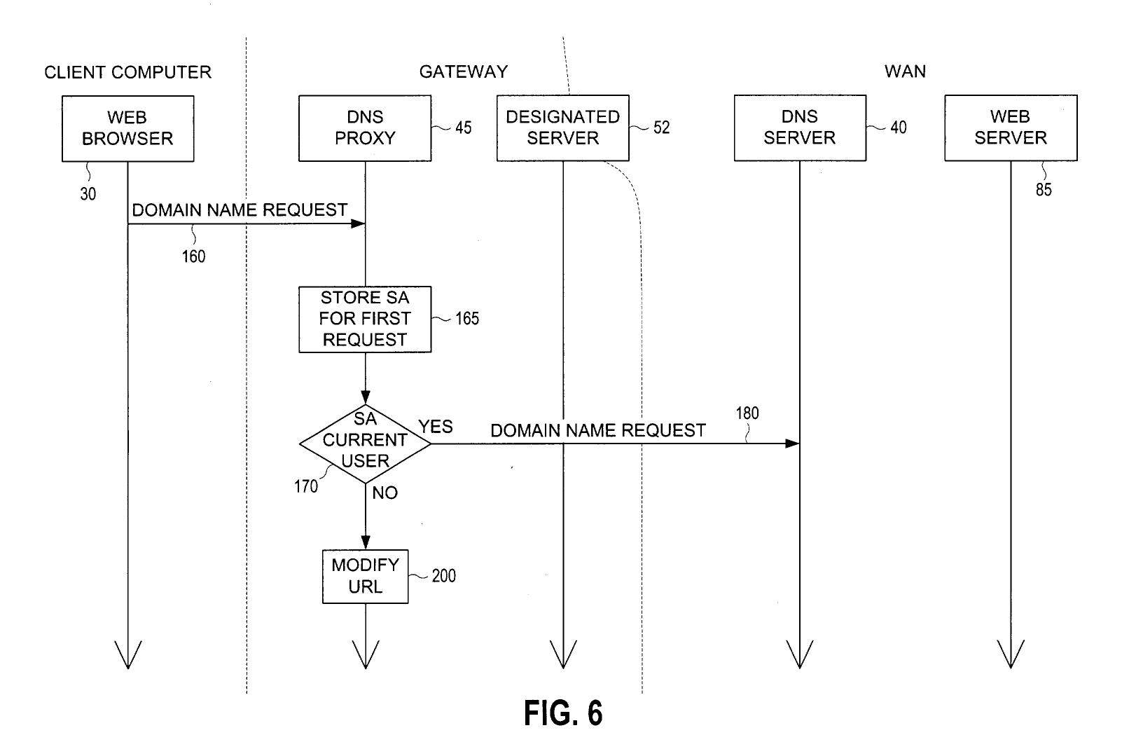

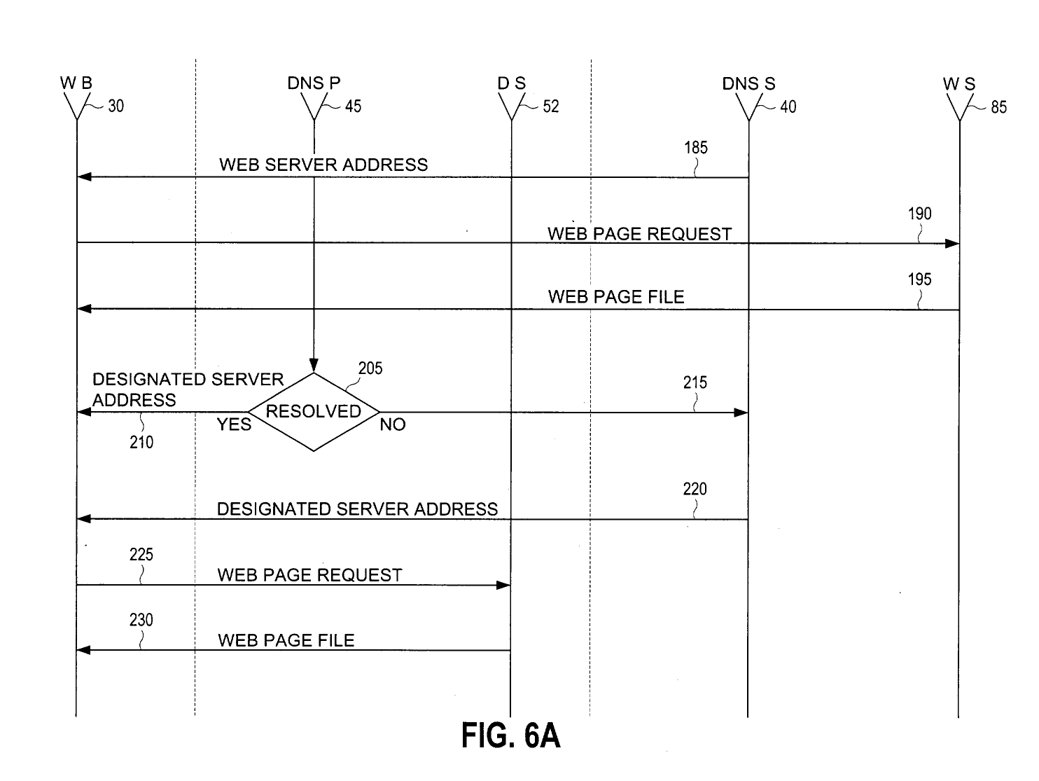

FIGS. 6 and 6A comprise a message diagram that depicts one possible process for redirecting web page requests when more than one user attempts to access the wide area network according to the present invention. According to this illustrative method, a web browser 30 may be executed by a client computer. The web browser 30 may receive a request from a user comprising a URL. In order to resolve the URL into a physical IP address, the web browser may dispatch a domain name request (connection 160). A DNS proxy 45, which may further comprise the access device, may receive the domain name request. In response, the DNS proxy 45 may store the source address of a first domain name request in a current user variable (step 165).

According to this illustrative method, the DNS proxy 45 may then compare the source address of the domain name request received from the web browser 30 to determine if the domain name request was sourced by the first user (step 170). If the source address of the domain name request is equal to the value stored in the current user variable, the domain name request may be forwarded to a DNS server 40 that may exist in the WAN space (connection 180). The DNS server 40 may then respond with the IP address of the web server on which the requested web page is stored (connection 185).

Once the web browser 30 receives the IP address for the web server on which the requested web page is stored, it may then dispatch a web page request (connection 190) to that IP address. The remote web server 85 may then respond by providing a web page file (connection 195). The browser 30 may then interpret the web page file and present to resulting images the user.

The present method further provides that if the source address of a domain name request is not equal to the address stored in the current user variable, the DNS proxy 45 will modify the URL comprising the domain name request (step 200). The DNS proxy may then attempt to resolve the URL. If the DNS proxy is able to resolve the URL (step 205), the DNS proxy may then return the IP address of the designated server to the web browser 30 (connection 210). Where the DNS proxy is not able to resolve the URL (step 205), the domain name request comprising the modified URL may be forwarded to the domain name server 40 (connection 215). In this case, the DNS server 40 will respond with the IP address of the designated server (connection 220).

Once the web browser 30 receives the IP address of the designated server either from the DNS proxy 45 or from the DNS server 40, it may then request the web page from the designated server 52 (connection 225). It should be noted that the designated server 52, according to this derivative method of the present invention, may exist either in the WAN space or it may further comprise an access device that enables access from a local area network to the WAN. The designated server 52 may also exist in the LAN space. The designated server may then respond by providing a web page file (connection 230). The web browser 30 may then interpret the web page file and present the result of its interpretation to the user.

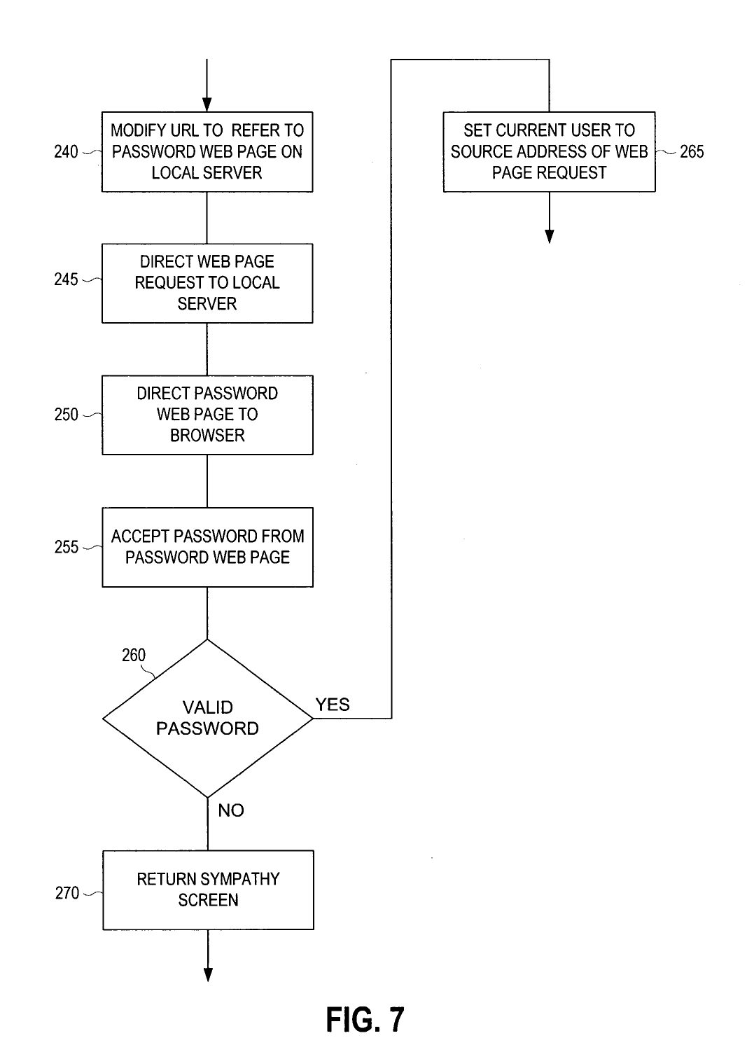

FIG. 7 is a flow diagram that depicts one illustrative method for allowing a subsequent user to preempt wide area network access captured by a first user according to the present invention. The method of connection management taught here may allow a subsequent user to gain access to the WAN where the subsequent user has greater authority than the first user. Such authority, according to one illustrative method of the present invention, may be authenticated through a password.

Continuing from the flow diagram presented in FIG. 6, a web page request from a subsequent user may be directed to a web page comprising a password retrieval mechanism where the access device has already granted the WAN connection to a first user. Hence, the method of the present invention may provide for modifying the URL of a subsequent web page request to refer to a password web page that may be stored on a local server (step 240). The web page request may then be directed to the local server (step 245). In most variations of this method, the local server may comprise the access device and may have access to configuration variables that control the access device. In one example method, the local server may further have access to the current user variable used by a DNS proxy server to determine if any particular web page request was sourced by a first user or a subsequent user. Such a DNS proxy server may further comprise the access device.

According to one illustrative variation of the method of the present invention, once a password is entered into the password web page by a user, the local server may accept the password from the web page (step 255). The local server may then compare the password for validity (step 260). If the password is found to be valid, the local server may set the current user variable to the source address of the subsequent web page request (step 265). If the password is not found to be valid, the server may then push a web page to the browser; said web page typically convey a “sympathy” message to the user (step 270). Such a sympathy message may indicate that the WAN connection is not available because it is being used by a different user.

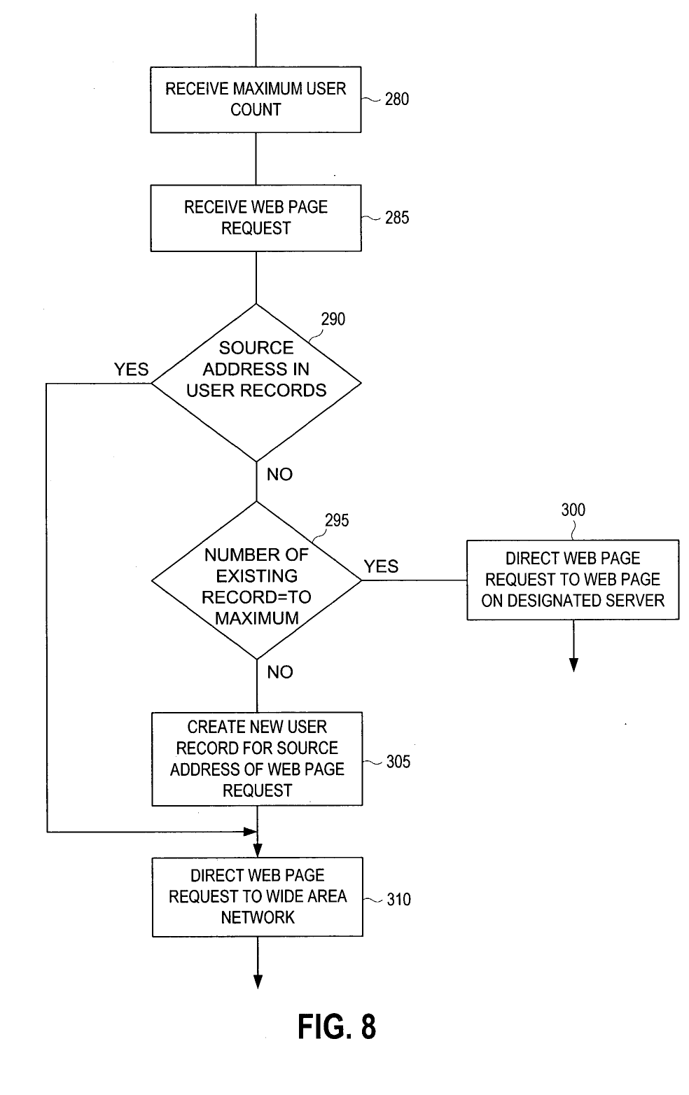

FIG. 8 is a flow diagram that illustrates one example method for allowing a variable number of users to share a connection to a wide area network according to the teachings of the present invention. An ISP may benefit by enabling additional users onto a single connection to a wide area network such as the Internet. The Internet is one example of a WAN to which a connection may be made through a shared channel and the method of the present invention is not intended to be limited in scope to this one example application.

According to this illustrative method, an access device may receive a maximum user count (step 280). This maximum user count may be a value received from an account management system that may be used by the ISP to control the maximum number of users any particular subscriber is entitled to simultaneously connect to the WAN. It should be noted that the maximum user count may be an optional step, for instance where an access device has previously received such a user count or where the maximum user count is programmed into the access device when it is manufactured.

As the access device receives web page requests (step 285), the method of the present invention provides that the source address for a web page request should correspond to a user record maintained by the access device (step 290). In the event that the source address of a web page request does correspond to a user record maintained by the access device, the web page request may be directed to the WAN (step 310).

If the access device cannot find a user record that corresponds to the source address of the web page request, the method of the present invention provides for creating a new user record if the number of existing records is not equal to the maximum user count (steps 295, 305). The new record should correspond to the source address of the pending web page request. According to one example method of the present invention, the user record may comprise a single field that may be used to store the source address of a web page request that may be received from a local area network. Once the new user record is created (step 305), the web page request may be directed to the wide area network (step 310).

In some cases, the access device may find that the number of existing user records is equal to the maximum user count value that it may have received from the ISP account management system. In this case a new user record will not be created. Rather, the method of the present invention provides for redirecting the web page request to a designated server (step 300). According to one derivative method of the present invention, redirecting the web page request to the designated server may be accomplished by modifying the URL comprising the subsequent web page request. Once this is accomplished, the modified web page request may be directed to the designated server.

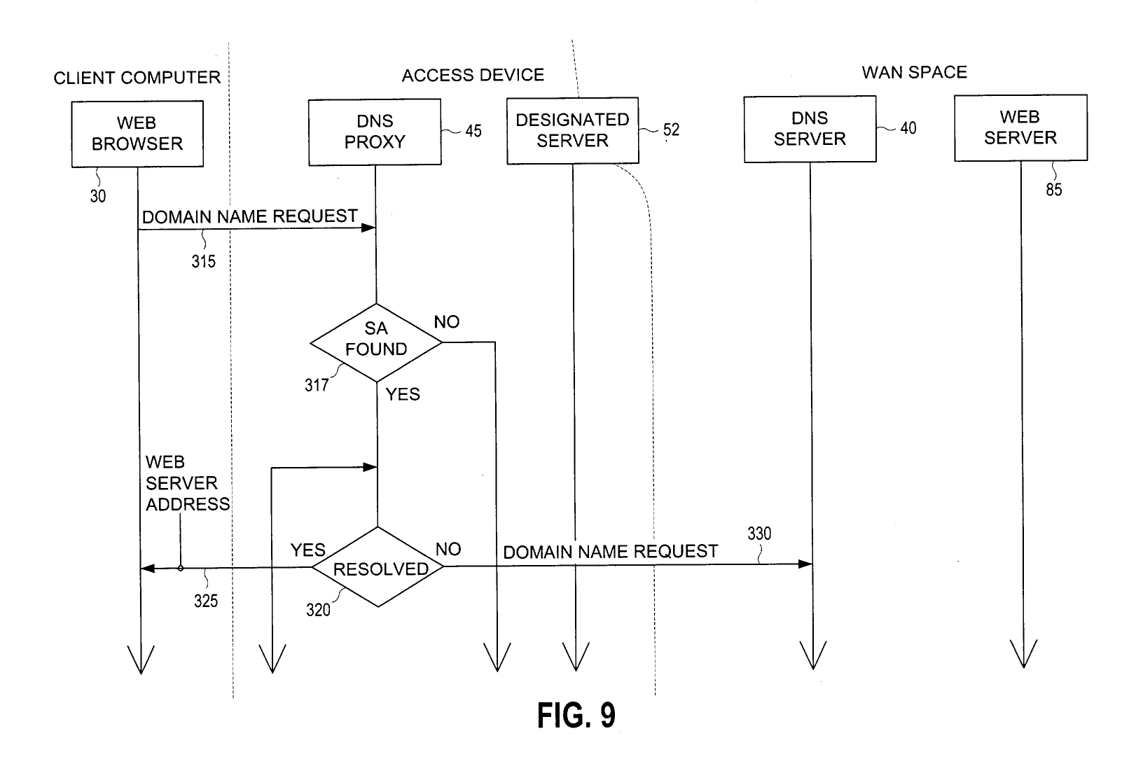

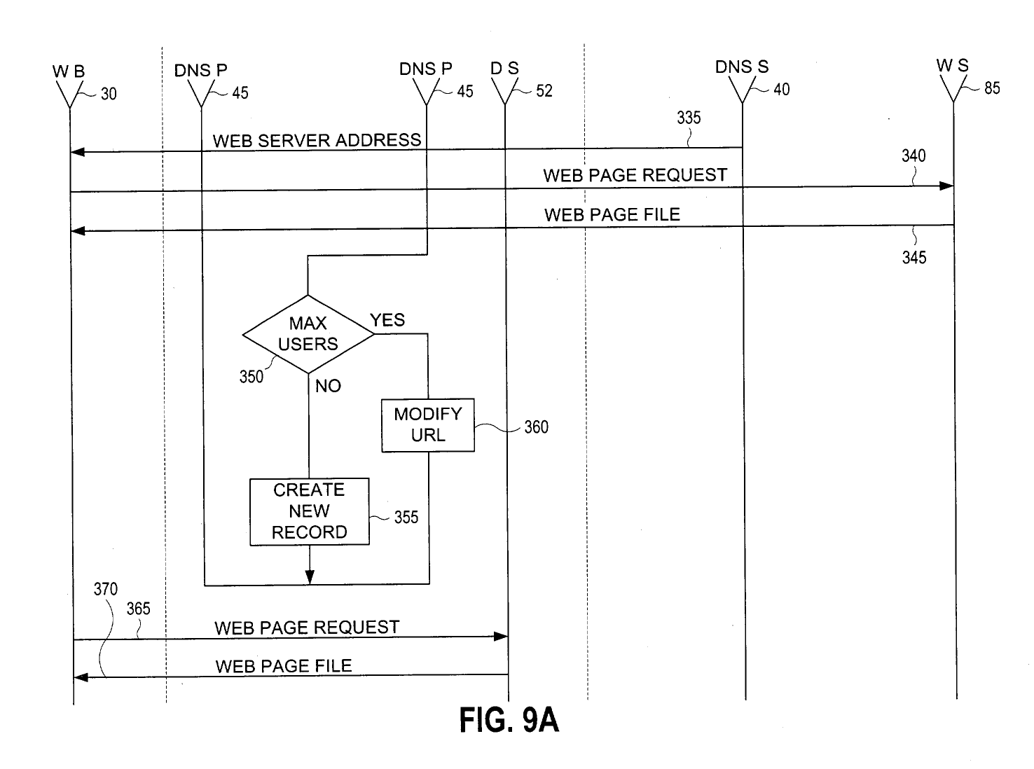

FIGS. 9 and 9A, collectively, are a message diagram that depicts one possible process for redirecting web pages when more than a maximum number of users attempt to access the wide area network. This example method provides that a web browser 30 may be executed on a client computer. When the web browser 30 accepts a request from a user for a particular web page, the web browser 30 may require resolution of a domain name. To this end, the web browser 30 may dispatch a domain name request (connection 315) to a DNS proxy 45. The DNS proxy 45 may comprise an access device that may be used to propagate web page requests from a local area network to a wide area network. The DNS proxy 45 may receive the domain name request from the client computer attached to the local area network. According to this illustrative method, the DNS proxy 45 may examine the source address of the domain name request in order to determine if it corresponds to an existing user record maintained by the access device (step 317).

In the event that an existing user record corresponding to the source address of the domain name request is found by the DNS proxy 45, the DNS proxy 45 may attempt to resolve the domain name into an IP address for the web server 85. If the DNS proxy 45 is able to resolve the name (step 320), the DNS proxy 45 will provide the IP address for the web server 85 back to the requesting web browser 30 (connection 325). If the DNS proxy 45 is not able to resolve the name, it may forward the domain name request (connection 330) to a remote DNS server 40 that may exist in the WAN space.

Once the requesting web browser 30 receives an IP address for the web server 85 either from the DNS proxy 45 or from a remote DNS server (connection 335), it typically uses the IP address to retrieve a web page from the web server 85. This is typically accomplished by dispatching web page request (connection 340). In response, the web server 85 typically conveys a web page file (connection 345) back to the web browser 30. The web browser 30 may then interpret the web page file and present the results of the interpretation to the user.

In the event that the DNS proxy 45 is not able to find an existing user record that corresponds to the source address of the domain name request (step 317) it must determine if the number of existing user records is equal to the maximum number of users that the access device may have been instructed to allow (step 350). According to one variation of this method, the access device may receive a maximum user count from a controlling authority such as a subscriber account management system operated by an ISP. It should be noted that a maximum user count may be received from any number of different sources and the scope of the present invention should not be limited to any particular examples provided herein. Again noting the possibility that a maximum user count may have been previously determined, receiving a maximum user count may be an optional step.

If the DNS proxy discovers that an additional user record may be created because the number of existing user records has not yet reached the maximum allowed by the maximum user count, the DNS proxy may create a new user record (step 355). Once this is done, the DNS proxy may then attempt to resolve the domain name comprising the domain name request dispatched by the web browser 30. Again, if the DNS proxy is unable to resolve the domain name, the request may be forwarded to the DNS server 40.

If the DNS proxy 45 discovers that an additional user record should not be created because the number of existing user records has already reached the maximum allowed by the maximum user count, the DNS proxy 45 will typically redirect the web page request. This may be accomplished by modifying the URL comprising the domain name request (step 360). According to one variation of this illustrative method, the URL is modified in order to refer to a web page that is stored on a designated server 52. Once this is accomplished, the DNS proxy 45 will attempt to resolve the modified URL into an IP address. In most cases, the DNS proxy 45 will be able to resolve the modified URL into an IP address for the designated server 52. Otherwise, the domain name request comprising the modified URL may be forwarded to a remote DNS server 40.

The web browser 30 will typically receive the IP address of the designated server 52 from either the DNS proxy 45 or the remote DNS server 40. Using this IP address, the web browser 30 may request a web page (connection 365) from the designated server 52. The designated server 52 may then respond with a web page file (connection 370). The web browser 30 may then interpret the web page file and present the results to the user.

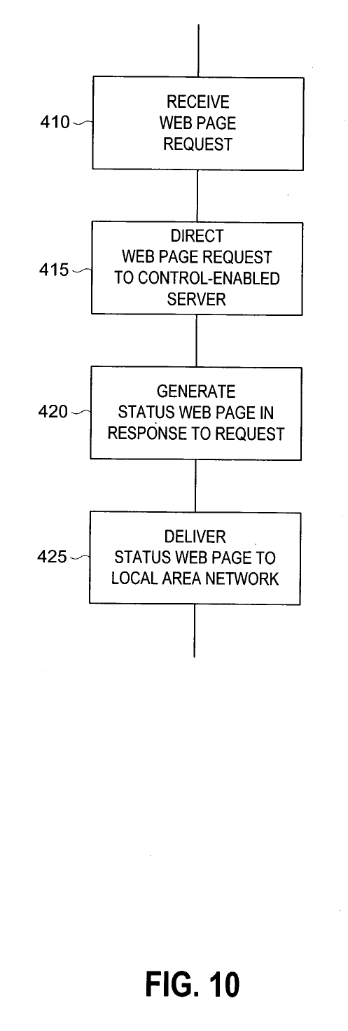

FIG. 10 is a flow diagram that illustrates one possible method for presenting the status of and/or configuring an access device according to the present invention. According to this example method, effective management of a connection to a wide area network may comprise process steps for presenting the status of an access device to a user if a connection to a WAN is not available. Likewise, process steps may be provided for allowing a user to configure the access device if a connection to a WAN is not available. First, a control-enabled server that is capable of ascertaining the status of the access device is provided. Accordingly, this illustrative method provides for receiving a web page request from a local area network (step 410). This web page request may then be directed to the control-enabled server if a connection to the wide area network is not available (step 415). This inventive method further provides that once the web page request is received, a status web page may be generated reflecting the configuration and/or the status of the access device (step 420). According to one variation of this method, the status web page may be generated in real-time according to the most current status information that the control-enabled server may receive. The status web page may then be delivered to the local area network (step 425).

According to one variation of the inventive method taught here, the control-enabled server may be capable of ascertaining the connection status between the access device and the wide area network. In such case, the process for providing status may comprise the incorporation of the connection status into the status web page that the control-enabled server generates. Once the status web page is generated, the control-enabled server may direct the web page to local area network.

In yet another variation that illustrates the method of the present invention, the control-enabled server may have the capability of determining the physical address that the access device uses to connect to the WAN. As a result, the control-enabled server may then generate a status web page comprising an indicator that reflects the physical address used to connect to the wide area network. The control-enabled server may then direct the web page to the local area network.

An additional derivative of the example method described here provides that the control-enabled server be capable of determining the bandwidth of a connection that may exist between the access device and the wide area network. The control-enabled server may then generate a status web page comprising an indicator that reflects the bandwidth of the access device to WAN connection. This status page may then be directed to the local area network.

In yet another example variation of the inventive method, the control-enabled server may be capable of determining the bit-error-rate exhibited by a connection between the access device and the WAN. This bit-error-rate may then be represented by an indicator that the control-enabled server may integrate into the status web page that it generates in response to a web page request it receives from the LAN. The control-enabled server may then direct the status web page to the LAN.

Effective management of a connection to a WAN may further comprise steps for presenting LAN connection information to a user. According to another illustrative variation of this method, the control-enabled server may be capable of creating a list of physical address of devices attached to the local area network. This method further provides that the control-enabled server generate a status web page comprising a list of physical addresses corresponding to the devices attached to the LAN. The control-enabled server may then direct the status web page to the LAN. This may be accomplished by “pinging” the local area network to discover attached devices.

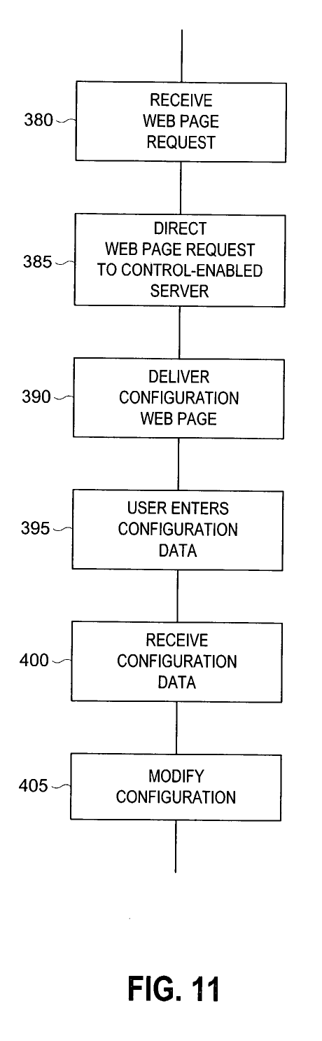

FIG. 11 is a flow diagram that depicts one illustrative method according to the present invention for controlling the configuration of an access device. According to the present invention, effective management of a connection to a wide area network comprises process steps for configuring the access device that may be used to propagate web page requests from a local area network to the WAN. According to this example method, an access device may be configured by providing a control-enabled server that is able to manipulate the access device configuration. This method further provides that the control-enabled server should receive web page requests (step 380) from a local area network if a connection to the wide area network is not available. Once the web page request is directed to the control-enabled server (step 385), a configuration web page may be delivered to the local area network (step 390).

According to this illustrative method, the present invention provides that the user may enter configuration data into the configuration web page (step 395). The control-enabled server may then receive the configuration data from the configuration web page (step 400) and then modify the configuration of the access device (step 405) accordingly.

In other various derivatives of the method of the present invention, the control-enabled server may receive a physical address that the access device should use when communicating with a local area network. Once the control-enabled server receives a physical address from the configuration web page, it may then modify control settings in a local area network interface circuit that may further comprise the access device to affect a configuration change to a new physical address for the LAN interface.

The method of the present invention may further be used to control the configuration of an access device that provides network address translation mapping. In such case, NAT mapping information may be received from a user through a configuration web page. The control-enabled server may then receive the NAT mapping information from the configuration web page and typically uses this information to set a routing table maintained by the access device. Typically, the routing table is used by the access device to control the routing of data packets addressed to or received from users attached to a local area network.

According to one example method of the present invention, effective connection management may further comprise process steps wherein the control-enabled server is capable of receiving an address for a domain name server from a user. This is typically accomplished by receiving an address from the configuration web page provided by the control-enabled server to the user. The control-enabled server may then receive the domain name server address. This address may then be stored in the access device and may be used by an address resolution service, such as a DNS proxy, when forwarding requests for domain name resolution that could not be service locally.

According to one additional variation of this method that illustrates the teachings of the present invention, an access device may further comprise a security firewall. Such a firewall typically requires configuration by a user. According to this variation of the inventive method, the control-enabled server may receive firewall configuration data in the configuration web page and use this to control the configuration of the firewall that may comprise the access device.

The methods of the present invention enable effective management of a connection between an access device and a wide area network. Ostensibly, these methods may be applied in the context of customer premises equipment, i.e. an access device that may be disposed between a LAN and the WAN. Hence, the present invention further comprises a CPE access device that operates in a mode commensurate with the teachings of the methods taught here.

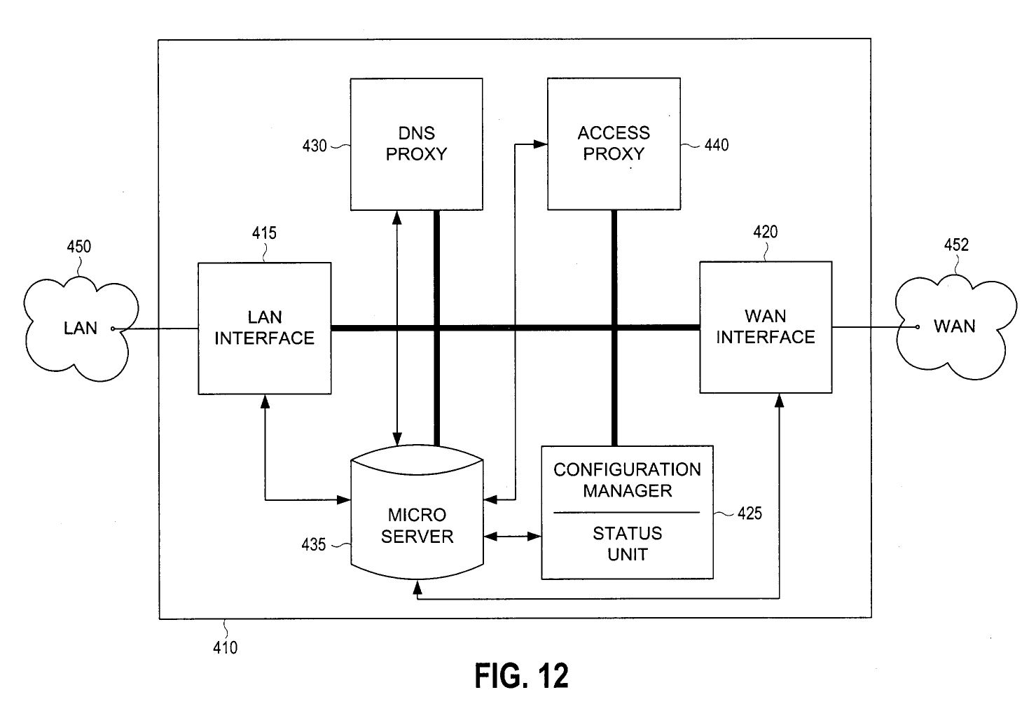

FIG. 12 is a block diagram that depicts one example internal structure for an access device according to the present invention. According to one embodiment of an access device that incorporates the features of the present invention, the access device 410 may comprise a local area network interface 415, a wide area network interface 420, a status unit 425 and an address resolution unit. According to one alternative embodiment of the access device, the address resolution unit may comprise a DNS proxy 430. The access device may further comprise a local server 435. According to one alternative embodiment of this invention, the local server may be a server that is capable of ascertaining the status of the access device. In yet another embodiment of this invention, the local server may be a server that is capable of manipulating the configuration of the access device.

The access device may further comprise a network access proxy 440. Such a network access proxy may comprise a network address translation capability that is able to direct web page requests received by way of the LAN interface 415 from various devices attached to a local area network 450 wherein each device attached to the local area network does so using a unique IP address. The network address translation capability provided by the network access proxy 440 may apply known network address translation techniques in order to direct web page requests from varied LAN IP addresses to a wide area network 455 by way of the WAN interface 420.

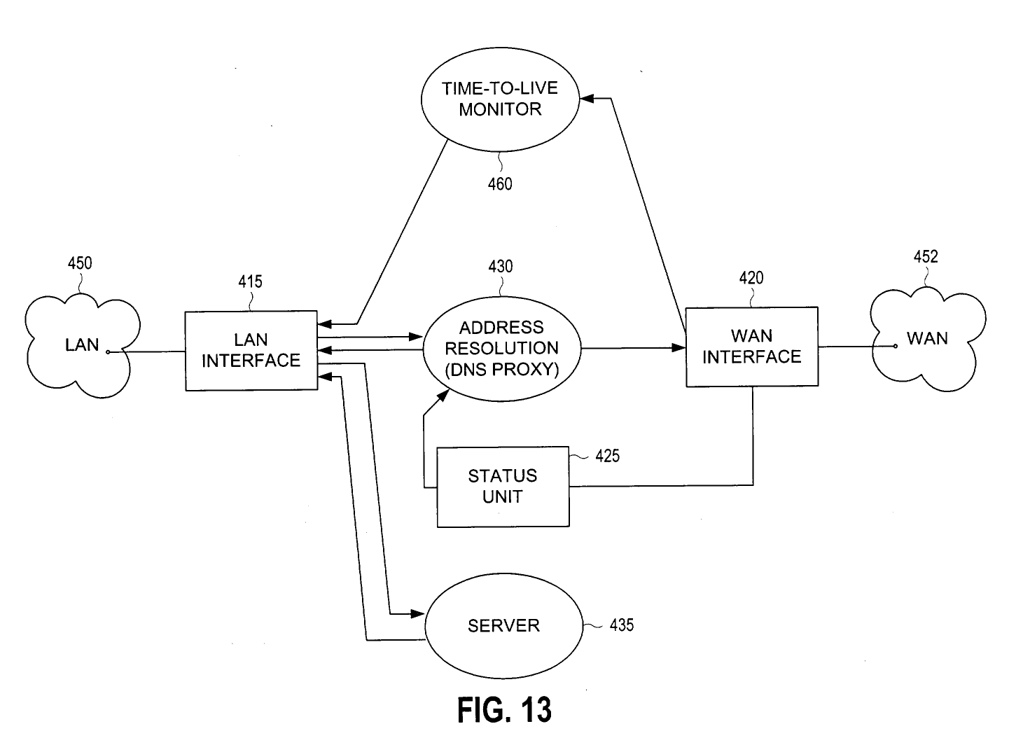

FIG. 13 is a data flow diagram that represents one possible embodiment of an access device that redirects web page requests to a local server when access to a wide area network is not available. According to this illustrative embodiment, the address resolution unit, i.e. DNS proxy 430, may receive web page requests from the local area network 450 by way of the LAN interface 415. Typically, the web page request comprises a first component wherein a requesting client process that may be executing on a client computer attached to the LAN requires address resolution. This first component typically comprises a domain name request. Hence, the address resolution module 430 may direct the domain name request to the WAN interface 420 if the status unit 425 comprising the access device indicates that a connection to the WAN 452 is available. In the case where the status unit 425 indicates that the connection is not available, the address resolution unit 430 may provide an IP address that refers to a local server by first generating the address and directing said address to the local area network in response to the web page request

According to one alternative embodiment of the present invention, when the DNS proxy 430 forwards a domain name request to the WAN, it may use a modified network address translation technique in order to direct domain name resolution response from a remote DNS server to be directed to a time-to-live monitor 460. Generally, the time-to-live monitor is advised when a domain name request is forwarded to the remote DNS server. The time-to-live monitor 460 may also be advised of the LAN IP address of the requesting client process. The forwarded request typically utilizes a special port number that signifies that the response ought to be directed to the time-to-live monitor and that coincides with the IP address of the client process that originated the request. The time-to-live monitor 460 of the present invention may then receive a domain name server translated address. Once the time-to-live monitor 460 receives the response, it may then use the port number to route the IP address back to the requesting client process.

In order to prevent excessive latency when a user attempts to access a remote web page in the case where the client process requesting the web page does not require immediate domain name resolution, the time-to-live monitor 460 may modify the translated address provided by a remote domain name server in order to reduce the time-to-live value comprising the modified address. This modification may only occur when the existing time-to-live value exceeds a pre-established threshold. The time-to-live monitor 460 may then direct the translated address, modified or not, to addressable device on the LAN that originally requested domain name resolution. This capability ensures that a web browser or other client process that has received an IP address in response to a domain name resolution request will not rely on that IP address for an extended period of time.

According to yet another alternative embodiment of the present invention, the access device 410 may further comprise a server 435. In such case, a user process executing on a client computer attached to the LAN 450 may be directed to the local server 435 by the DNS proxy 430. Once the user process receives the IP address for the local server 435, it may then request a web page from the local server. The local server may then respond with a web page file. The user process may then interpret the web page file and present the results to the user. It should be noted that such a user process may be a web browser.

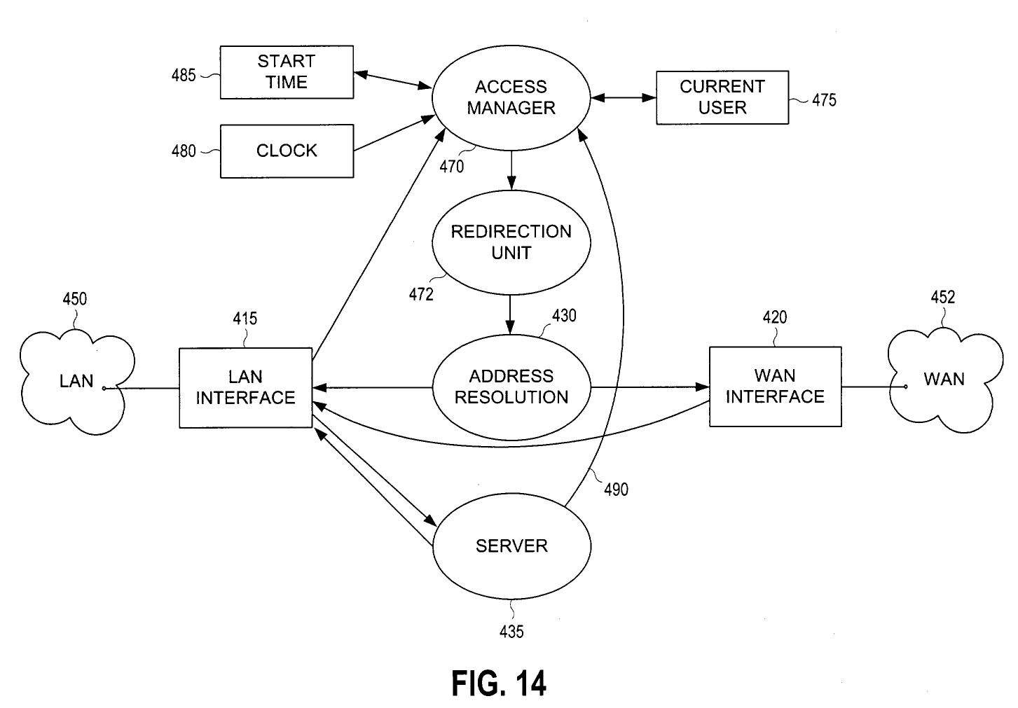

FIG. 14 is a flow diagram that illustrates the operation of one possible embodiment of an access device that redirects web page requests from a local area network when more than one user attempts to access a wide area network. According to this embodiment, an access device comprises a local area network interface 415 and a wide area network interface 420. It further comprises an access manager 470, a redirection unit 472 and an address resolution unit 430.

According to this one illustrative embodiment of the present invention, the access manager 470 may receive a first web page request from the local area network interface 415. The access manager may then extract the source address from the first web page request and store this in a current user variable 475. In this illustrative embodiment, the access manager is primarily concerned with the first component of a web page request, namely a request for domain name resolution. The domain name request comprising a first web page request may then be forwarded to the address resolution unit 430 comprising the access device. Typically, the address resolution unit 430 comprises a DNS proxy. The address resolution unit 430 may attempt to resolve the domain name into an IP address that then may be returned to the LAN 450 by way of the LAN interface 415. In the event that the address resolution unit 430 is not able to resolve the domain name, it may forward the domain name request to the WAN interface 420. The domain name request may then find its way out onto the WAN where it is directed to a domain name server. According to one variation of this invention, the address resolution unit 430 may accept an IP address for a domain name server that may be contacted by way of the WAN interface 420.

According to this example embodiment, the access device may further comprise a redirection unit 472. In the case where the access manager receives a subsequent web page request comprising a domain name request, the access manager compares the source address of the subsequent web page request to the value stored in the current user variable 475. If the comparison is unsuccessful, the access manager may route the domain name request to the redirection unit 472. The redirection unit 472 may then modify the URL comprising the subsequent web page request. Typically, the modification causes the domain name request to refer to a web page stored on a designated server. If the comparison is successful, the redirection unit merely forwards the web page request (i.e. domain name request) to the address resolution unit 430. The address resolution unit 430 may then attempt to resolve the modified domain name request into an IP address that may then be returned to the LAN 450 by way of the LAN interface 415. Likewise, the address resolution unit 430 typically forwards an irresolvable domain name request to the WAN 452 so that it may be directed to a domain name server.

In the event where the address resolution unit 430 forwards the domain name request comprising a web page request to the WAN 452, a domain name server may respond with an IP address for a server corresponding to the URL contained within the domain name request. Such a response is typically received by the WAN interface 420 and directed back to the LAN interface 415. In the case where multiple client computers are attached to the LAN 450, the access device may employ known NAT techniques to route responses received by way of the WAN interface 420 to the appropriate LAN IP address.

According to yet another alternative embodiment of the present invention, the access device may further comprise a server 435 that may be used to store a web page. Commensurate with the teachings of the present invention, the redirection unit 472 may modify the URL comprising a web page request to refer to a web page stored on the server 435. The address resolution unit 430 may then respond with an IP address corresponding to the server 435. A client process executing in the LAN space may use this IP address to retrieve a web page stored on the server 435.

In yet another alternative embodiment of the present invention, the access device may further comprise a clock 480. Typically, when a first client process executing in the LAN space dispatches a web page request, the access manager may optionally start a timer by reading a real-time value from the clock 480 and then storing this in a start time variable 485. When a subsequent web page request arrives at the access manager, the access manager 470 may compare the source address of the subsequent web page request to the value stored in the current user variable 475. If the comparison is successful, the access manager typically resets the timer by reading a new real-time value from the clock 480 and storing it in the start time variable 485.

Where the access manager discovers that a subsequent web page request was sourced from a different user (i.e. the source address of the subsequent web page request does not match the value stored in the current user variable 475), the access manager may read a real-time value from the clock 480 and determine the difference between the current real-time reading and the value stored in the start time variable 485. If the difference exceeds a pre-established threshold, the access manager may store the source address of the subsequent web page request in the current user variable 475. This allows a new client device attached to the LAN 450 to gain access to the wide area network once a first user has stopped using the connection for a given period of time.

An additional example of this invention provides that where the access manager 470 receives a subsequent request for a web page having a source address that does not match the value stored in the current user variable 475, the redirection unit 472 may modify the URL comprising the subsequent web page request to refer to a password web page. Typically, such a password web page would be stored on the server 435 comprising the access device, but it may be stored on any designated server. A client process executing in the LAN space may then retrieve the password web page using the IP address provided by the address resolution unit 430 in response to the modified URL. The server 435 may then accept a password that a user may enter into the password web page. Where the server 435 is able to validate the password received from a user, it may generate a password override signal 490. In such case, the access manager 470, upon receiving the password override signal 490, may store the source address of the subsequent web page request in the current user variable 475 and forward the web page request comprising a domain name request to the address resolution unit 430.

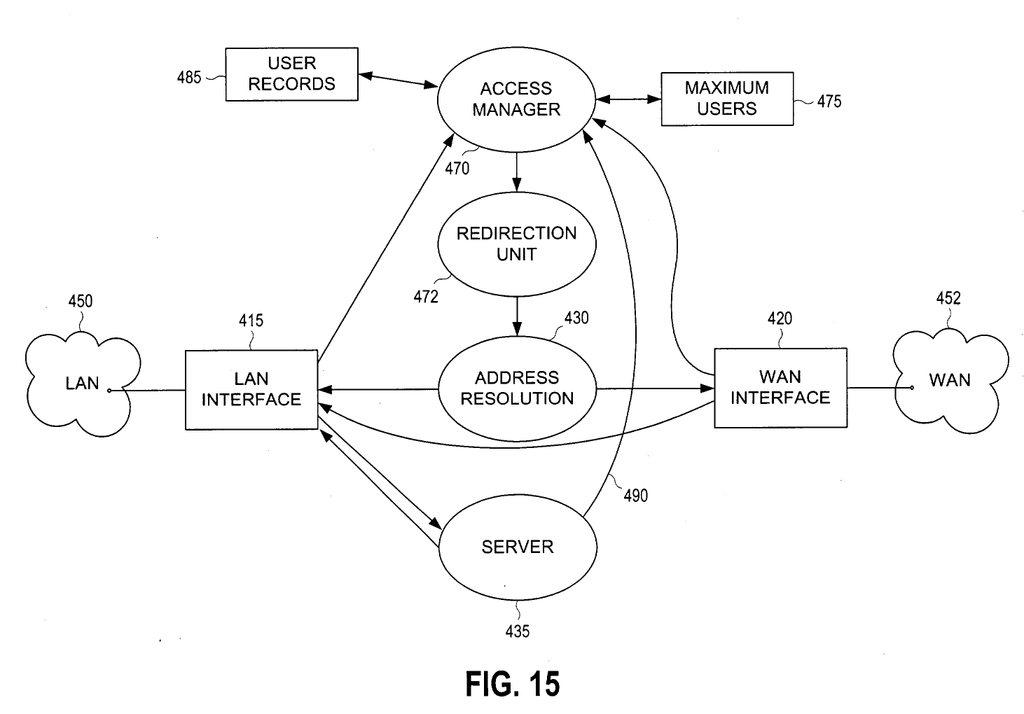

FIG. 15 is a flow diagram that depicts one example internal structure of an access unit that redirects a web page request according to the present invention when more than a maximum number of users attempt to access a wide area network. According to this example embodiment of the present invention, a web page request, which may comprise a first component known as a domain name request, may arrive from a local area network 450 by way of a LAN interface 415 that comprises the access device. The domain name request is typically directed to an access manager 470 that may also comprise the access device. Further comprising the access device are a redirection unit 472 and an address resolution unit 430. This embodiment further comprises a WAN interface 420 that may be used to establish a connection to a wide area network 452.

Upon starting operation, the access manager 470 typically receives a maximum user count that it stores in a maximum users variable 475. According to this illustrative embodiment, upon start-up the access manager 470 may communicate with an account management system that may be present in the WAN space. In some instances, such an account management system may be operated by an ISP that earns revenue by selling subscriptions for access to the wide area network. Hence, the account manager 470 may receive the maximum user count by way of the WAN interface 420. In other alternative embodiments of this invention, the maximum user count may be received by alternative channels and the scope of the present invention is not intended to be limited to the one example means of receiving a maximum user count by way of the WAN.

Once the access manager has received a maximum user count, it is ready to process requests for web pages that it may receive from the LAN 450. It is once again emphasized that the maximum user count is typically received only once, and may be updated with a new value by an access authority. For the purposes of this discussion, and as already previously taught, a web page request typically comprises a first component known as a domain name request. A client device, such as a web browser, may be executed in the LAN space on a computer attached to the LAN 450. The second component of the web page request typically comprises a file request targeted at a specific IP address. The specific IP address is normally obtained by the client process through a domain name request process that it may initiate and that is received by the access manager 470.

When a web page request arrives at the access manager 470, the access manager typically extracts the source address from the web page request. The access manager then attempts to find an existing user record in a user records database 485 that it may manage. If the access manager 470 is able to discover an existing user record that corresponds to the source address of the current web page request, it typically directs the web page request to the address resolution unit 430 by way of the redirection unit 472.

According to this illustrative embodiment, the address resolution unit 430 attempts to resolve the URL comprising a domain name request into a physical IP address. If the address resolution unit 430 is successful in resolving the address, it may return the IP address to the LAN interface 415. The LAN interface 415 may then propagate the IP address back to the client process executing in the LAN space that originally requested domain name resolution. In the event that the address resolution unit 430 is unable to resolve the address, it typically forwards the domain name request to the WAN interface 420 so that it may be propagated out into the WAN space. Once the domain name request is forwarded to the WAN, it may be directed to a domain name server. According to this illustrative embodiment, the address resolution unit 430 may be made privy to the physical address of the DNS server located in the WAN space so that it may properly forward unresolved domain name requests.

Once the domain name request is serviced by the DNS server in WAN space, the response comprising an IP address may be received by the WAN interface 420 and propagated out to the LAN 450 by way of the LAN interface 415. Where multiple client devices are attached to the LAN 450, the access device of the present invention may employ known network address translation techniques to route the response received from the WAN to the appropriate physical address in the LAN space.

In the event that the access manager 470 cannot find a record in the current user records database 485 that corresponds to the source address of a particular web page request, the access manager may create a new user record corresponding to the source address of that particular web page request. The access manager will only create a new user record if the total number of records stored in the user records database 485 is less than that specified in the maximum users variable 475. If the access manager discovers that the user records database 485 is full, it will not create a new user record. In this case, the access manager 470 will direct the web page request to the redirection unit 472. The redirection unit 472 may then redirect the web page request to a designated server. Such redirection may be accomplished by modifying the URL comprising the domain name request received by the access manager 470 from the LAN interface 415.

The access device of the present invention, according to this illustrative embodiment, may further comprise a server 435. In such case, the address resolution unit 430 may respond to a client process executing in the LAN space with the IP address of the local server 435 comprising the access device. Once the client process executing in the LAN space receives the IP address of the local server 435, it may request a web page from the local server 435. The local server 435 responds by providing a web page file back to the LAN by way of the LAN interface 415; this is directed to the requesting client process.

FIG. 12 further illustrates that the access device 410 may comprise a status unit 425. According to at least one illustrative embodiment of the present invention, the access device 410 comprises a control-enabled server 435. The control-enabled server 435 typically receives status information from the status unit 425. According to at least one illustrative embodiment of the invention, the address resolution unit will respond with an address referencing the control-enabled server if a connection to the wide area network in not available. The control-enabled server 435 typically comprises a status module. The status module generates a web page definition based on a template and status information that the control-enabled server may receive from the status unit 425. According to one embodiment of the present invention, the template comprises a web page definition authored in a hypertext markup language. Generally, the template further comprises status field definitions that may be used to direct the status module to incorporate status information into a final HTML page description file that the status module generates in response to a web page request that the control-enabled server 435 may receive from the local area network. Hence, the status module may generate HTML page files in substantially real-time whenever the status of the access device is requested by a client process executing in the LAN space.

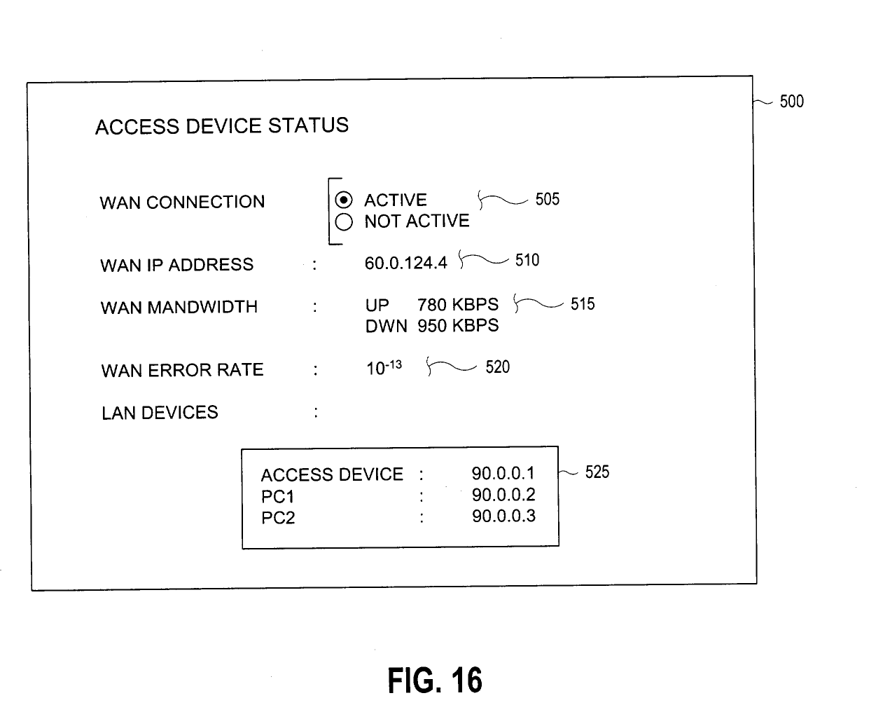

FIG. 16 is a pictorial representation of one possible format for a status web page that may be generated by the access device in response to a web page request referencing said status web page. According to one embodiment of the present invention, the status unit 425 may determine if the WAN interface 420 is actively connected to a wide area network 452. A status signal reflecting this information may then be directed to the control-enabled server 435. The template stored in the access device that defines the formatting and placement of information on the status web page may comprise a directive that causes the status module to integrate an indicator that reflects WAN connections status into the status web page 500. Accordingly, the status module may generate a web page definition that comprises the WAN connections status indicator 505. According to one embodiment of the access device status web page 500, the WAN connection status indicator 505 may comprise a two-state indicator capable of indicating if the WAN connection is either active or not active.

The template that defines the structure of the status web page, according to yet another alternative embodiment of this invention, may comprise a directive that causes the status module to receive a value reflecting the physical IP address that the access device 410 actively uses to connect to the wide area network. Once the status module receives this information it may cause the status web page definition file to comprise a WAN IP address indicator 510.

The status web page template used by the status module as the basis for the status web page file that it generates may further comprise a directive that causes the status module to integrate a WAN bandwidth indicator 515 into the status web page definition file. This indicator may comprise separate indicators for uplink and downlink bandwidth. The status web page template may further comprise a directive that causes the status module to integrate a WAN bit-error-rate indicator 520 into the status web page definition file. The status unit 425 typically monitors the LAN interface 420 in order to create statistical profiles for the bandwidth and bit-error-rate of a connection to a wide area network. In operation, the status module comprising the control-enabled server may query the status unit 425 anytime a new status web page needs to be generated.

According to one embodiment of the present invention, the status unit 425 comprising the access device 410 may further receive connectivity information from the LAN interface 415. Typically, the status unit 425 will interact with the LAN interface 415 in order to identify devices attached to the LAN according to the source IP addresses of data packets received by the access device 410 by way of the LAN interface 415. The status unit 425 may then maintain a list of devices according to IP address that may be attached to the LAN 450. The status web page template, as used in this embodiment of the invention, comprises a directive that causes the status module to integrate an enumeration of devices 525 attached to the LAN 450 according to their respective IP addresses into the status web page.

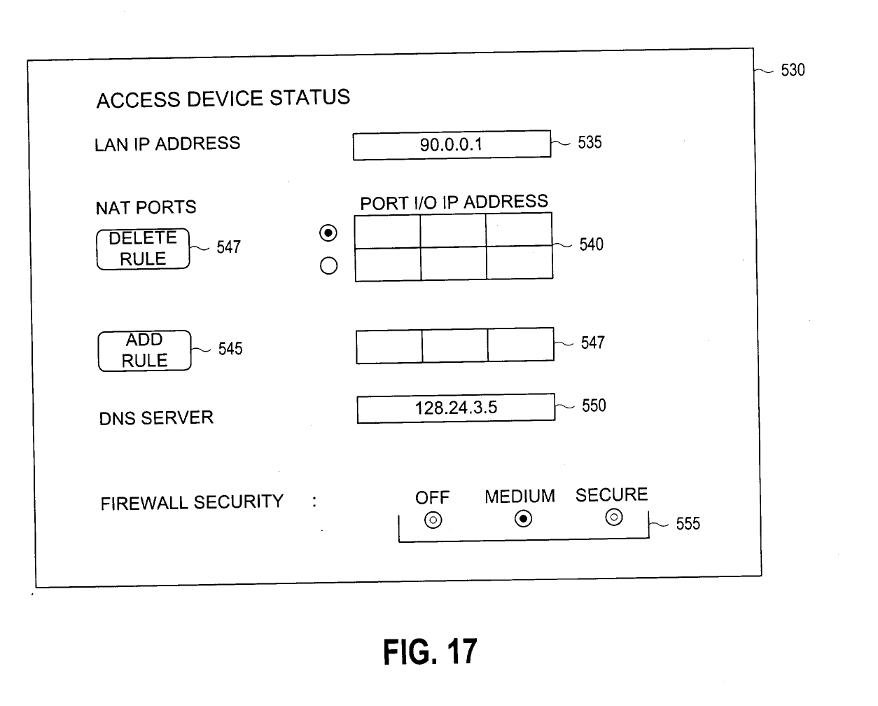

FIG. 17 is a pictorial representation of one example format of a configuration web page that may be used to configure an access device according to the present invention. According to this example embodiment, the control-enabled server 435 comprising the access device 410 may further comprise a configuration module. According to this illustrative embodiment, the address resolution unit may respond with the address of the control-enabled server 435 if a connection to the wide area network is not available. In response to a web page request received from the LAN 450, the control-enabled server 435 may respond by providing a configuration web page to the requesting device by way of the LAN interface 415. The configuration web page 530 may comprise a data entry control for receiving a LAN IP connection address 535. According to this embodiment, the control-enabled server 435 may accept an IP address entered by a user into the LAN IP connection address data entry control 535. Once the control-enabled server 435 receives this connection address, the configuration module may causes configuration registers comprising the LAN interface 415 to be set to the address specified by the user using this data entry control.

The configuration web page 530, according to yet another alternative embodiment of the present invention, may further comprise a NAT port mapping data entry control 540. According to this example embodiment, the NAT port mapping data entry control 540 may comprise a table wherein each row comprises three columns. One of these columns may comprise a port number column 541. A second column may comprise an input/output indicator column 542. A third column may comprise a local IP address column 543. Each row may further comprise a selection button 544. According to this embodiment of the invention, the configuration web page 530 may be dynamically created whenever it is requested in order to reflect the current NAT mapping rules that the access device 410 may have stored and that it uses to govern NAT routing.

Using the configuration web page 530, a user may select any or all of the NAT mapping rules represented in individuals rows in the data entry control for NAT port mapping 540. Once selected, the user may actuate a delete rule command button 547 that may further comprise the access device configuration web page 530. The configuration web page 530 typically also further comprises an additional NAT rule row data entry control 547 and an add rule command button 545. Using this add rule command button 545, a user may causes the control-enabled server 435 to retrieve a user entered NAT port rule from the data entry control 547. The control-enabled server 435 may then use this information to create a new NAT port mapping rule that may then govern subsequent network address translation functions provided by the access device.

The configuration web page 530, according to yet another alternative embodiment of the present invention, may further comprise a data entry control for receiving a DNS server IP address 550. A user may enter a value into the DNS server IP address data entry control 550 in order to specify the physical address of a remote DNS server. The control-enabled server 435 may then receive the IP address and direct this address to the address resolution component comprising the access device 410. Typically, this component is a DNS proxy 415.

In some embodiments of the present invention, the access device may provide firewall capabilities. In this case, the level of security that the firewall provides as it protects the local area network attached to the LAN interface 415 may be specified by a user using a firewall security data entry control 555 that may further comprise the access device configuration web page 530. According to one embodiment of this invention, the firewall security data entry control 555 comprises a radio button grouping wherein the control provides one radio button for each level of security that the firewall may recognize as a directive. According to one illustrative example that is not meant to limit the scope of the present invention, three radio buttons may be provided; off, medium and secure. The control-enabled server may receive the radio button settings as entered by a user and accordingly signal a firewall component that may further comprises the access device.

The method and apparatus of the present invention relies heavily on the notion of redirecting a web page request received from a local area network to either a local server or a designated server as a mechanism for managing the connection to a wide area network. In a typical operating scenario, a web page request may be originated by a client process that is executing on a device attached to the local area network. Such a client process is likely to be a web browser. Since a web page request that is originated by such a client process comprises two components, a domain name request and a web page file request, is important to note that the browser typically communicates directly with a server to retrieve a desired web page once the browser learns the IP address of that server. However, the web browser or any other client process must typically access the server through an alias. This alias is commonly known as a URL. Hence, when a web page request is redirected according to the teachings of the present invention, it may be redirected by modifying the domain name request prior to address resolution. Once the domain name request is modified, the modified URL may then be subject to address resolution. The resolving server, which according to the present apparatus and method may be either a DNS proxy or a remote DNS server, responds with the physical IP address of the server; this is directed back to the requesting client process (i.e. the web browser).

A typical web page request is directed at a specific file that is stored on a specific server wherein the specific server is referenced by a URL alias. In general, the web browser receives a physical IP address for the specified server and then dispatches a request directly to the server in order to retrieve the specific file. It is important to note that the redirection technique taught here typically modifies the URL alias for the specific server. The client process may then use the IP address that it received from the resolving DNS server (or proxy) to dispatch a file request to either a local server comprising the access device or some other designated server that may exist in either the LAN or WAN space. This file request typically comprises a reference to the original web page requested from the original server.

In most cases, when the web page request is redirected to a different server, the new target server will not have the originally requested web page. In order to overcome this, the local server or the designated server to which the web page request is redirected according to the teachings of the present invention may need to respond to what is, in essence, a request for an unknown web page. This may be accomplished by enabling the responding server to provide a default web page to the original requesting client process whenever it receives a web page request that references a web page that is not stored on the server. This default web page, in some embodiments of the present invention, may be a password web page or it may be any type of informational web page that may aid a user in managing the connection from the access device to the wide area network. In most cases, this default web page may provide hyperlinks to other connection management web page that may be stored on either the local server, the designated server or any other server that may be referenced by the hyperlink.

### ALTERNATIVE EMBODIMENTS

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

Further, while various embodiments of the invention have been described, it will be apparent to those of ordinary skill in the art that many more embodiments and implementations are possible that are within the scope of this invention.

What is claimed is:

1. A method for propagating web page requests from a local area network to a wide area network comprising the steps of:
receiving a web page request from the local area network;
determining if a connection to the wide area network is available;
modifying a URL comprising the web page request to refer to a web page stored on a local server and also directing the web page request to the local server if the wide area network connection is not available; and
directing the web page request to the wide area network if the wide area network connection is available.

2. The method of claim 1 further comprising the steps of:
receiving a domain name server translated address in response to a web page request received from an addressable device attached to the local area network comprising an internet protocol address and a time-to-live value;
reducing the time-to-live value comprising the domain name server translated address if the time-to-live value exceeds a pre-established value, and
providing either the received or modified domain name server translated address to the addressable device in response to the web page request.

3. The method of claim 1 further comprising the steps of:
storing a web page on the local server;
retrieving the web page in response to a web page request redirected to said local server; and
directing the retrieved web page to the local area network.

4. The method of claim 1 further comprising the step of providing a control-enabled server capable of ascertaining status of the CPE access device and wherein the step of modifying a URL comprising the web page request to refer to a web page stored on a local server comprises the step of modifying a URL comprising the web page request to refer to a web page stored on the control enabled server and further comprising the steps of:
directing the web page request to the control-enabled server;
generating a status web page in response to the web page request received by the control-enabled server; and
delivering the generated status web page request to the local area network.

5. The method of claim 4 wherein the step of generating a status web page comprises the steps of:
determining the status of a connection between the CPE access device and a wide area network; and
incorporating the connection status into the status web page.

6. The method of claim 1 further comprising the step of providing a control-enabled server capable of controlling the configuration of the CPE access device and wherein the step of modifying a URL comprising the web page request to refer to a web page stored on a local server comprises the step of modifying a URL comprising the web page request to refer to a web page stored on the control enabled server and further comprising the steps of:
directing the web page request to the control-enabled server;
delivering a configuration web page to the local area network; and
receiving configuration data from the configuration web page and setting the configuration of the CPE access device according to the configuration data.

7. A method for propagating web page requests from a local area network to a wide area network comprising the steps of:
receiving a first web page request from a first addressable device attached to the local area network;
storing the address of the first addressable device in a current user variable;
forwarding the first web page request to the wide area network;
providing the capability to receive a subsequent web page request from the local area network;
modifying a URL comprising the subsequent web page request to refer to a web page stored on a designated server and also directing the modified web page request to the designated server if the source address of the subsequent web page request does not equal the value stored in the current user variable;
and directing the subsequent web page request to the wide area if the source address of the subsequent web page request equals the value stored in the current user variable.

8. The method of claim 7 further comprising the steps of:
receiving a web page from the designated server in response to a web page request redirected to said designated server; and
directing the received web page to the local area network.

9. The method of claim 7 wherein the step of providing the capability to receive a subsequent web page request from a local area network comprises the steps of:
setting a timer when the address of the first addressable device is stored in the current user variable;
receiving a subsequent web page request; and
extracting a subsequent source address from the subsequent web page request and also storing said subsequent source address in the current user variable if said timer has expired.

10. The method of claim 7 wherein the step of modifying a URL comprising the subsequent web page request and directing the modified web page request to the designated server if the source address of the subsequent web page request does not equal the value stored in the current user variable comprises the steps of:
modifying a URL comprising the subsequent web page request to refer to a password override web page stored on a designated server and directing the subsequent web page request to the designated server if the subsequent web page request was not sourced by the first addressable device;
directing the password override web page from the designated server to the local area network;
providing the capability in the designated server to receive a password entered by a user into the password override web page and also generating a password override signal if the received password is valid; and
setting the current user variable to the source address of the subsequent web page request if the password override signal is received.

11. A method for propagating web page requests from a local area network to a wide area network comprising the steps of:
receiving a maximum user count;
receiving a web page request from an addressable device attached to the local area network;
directing the web page request to the wide area network if an existing user record corresponds to the addressable device;
creating a new user record corresponding to the addressable device from which the web page request was received and also directing the web page request to the wide area network if an existing user record corresponding to the addressable device does not exist and the number of existing user records is not equal to the maximum user count; and
redirecting said web page request to a designated server if an existing user record corresponding to the addressable device does not exist and if the number of existing user records is equal to the maximum user count.

12. The method of claim 11 wherein the step redirecting said web page request to a designated server comprises the steps of:
modifying a URL comprising the web page request to refer to a web page stored on a designated server; and
directing the modified web page request to the designated server.

13. A customer premises equipment (CPE) access device comprising:
local area network interface;
wide area network interface;
status unit capable of generating a redirect signal if the wide area network interface is not actively connected to a wide area network; and
address resolution unit that is capable of:
receiving web page requests from the local area network;
generating an internet protocol address that refers to a local server and also providing the generated address to the local area network in response to the web page request if the redirect signal is active; and
directing the web page request to the wide area network if the redirect signal is not active.

14. The CPE access device of claim 13 further comprising a time-to-live monitor that is capable of:
receiving a domain name server translated address in response to a web page request sourced by an addressable device attached to the local area network comprising an internet protocol address and a time-to-live value;
modifying the translated address by reducing the time-to-live value if the time-to-live value exceeds a pre-established value; and
propagating the translated address, modified or not, to the addressable device.

15. The CPE access device of claim 13 further comprising:
local server capable of storing a web page and responding to web page requests redirected to said local server by retrieving the web page and directing it to the local area network interface.

16. The CPE access device of claim 13 further comprising a control-enabled server that:
is able to ascertain status of the CPE access device;
is able to generate a status web page that comprise indicators that reflect the status of the CPE access device; and
is able to provide the generated status web page to the local area network interface and wherein the local server address generated by the address resolution unit refers to the control enabled server.

17. The CPE access device of claim 16 wherein the control-enabled server comprises a wide area network connection monitor that is capable of indicating if the wide area network interface is actively connected to a wide area network and wherein the control-enabled server is capable of generating a status web page that comprises an indication provided by the wide area network connection monitor.

18. The CPE access device of claim 13 further comprising a control-enabled server that:
is able to provide a configuration web page to the local area network interface;
is able to retrieve configuration data from the configuration web page provided to the local area network interface; and
is able to set the configuration of the CPE access device according to the configuration data and wherein the local server address generated by the address resolution unit refers to the control enabled server.

19. A customer premises equipment (CPE) access device comprising:
local area network interface;
wide area network interface;
access manager that is capable of:
receiving a first web page request from the local area network interface;
extracting a first source address from said web page requests;
storing the extracted first source address in a current user identifier variable;
directing the first web page request to the wide area network interface;
receiveing a subsequent web page request from the local area network interface;
extracting a subsequent source address from the subsequent web page request; and
forwarding the subsequent web page request;
redirection unit that is capable of:
receiving the subsequent web page request from the access manager;
modifying the URL comprising the subsequent web page request to refer to a web page stored on a designated server if the source address extracted from the subsequent web page request does not match the source address stored in the current user identifier variable; and
forwarding the subsequent web page request; and
address resolution unit that is capable of:
receiving the subsequent web page request from the redirection unit;
generating an internet protocol address and also directing the generated address to the local area network interface in response to the web page request if the URL comprising the subsequent network request can be resolved; and
directing the subsequent web page request to the wide area network interface if the URL comprising the subsequent network request can not be resolved.

20. The CPE access device of claim 19 further comprising:
designated server that is capable of storing a web page and responding to web page requests redirected to said designated server by retrieving the web page and directing it to the local area network interface.

21. The CPE access device of claim 19 wherein the access manager further comprises:
timer that is:
initiated when the source address of the first web page request is stored in the current user identifier variable; and
reset whenever a web page request is received having a source address equal to the value stored in the current user variable and wherein the access manager stores the source address extracted from a subsequent web page request in the current user identifier variable if the timer has expired.

22. The CPE access device of claim 19 wherein the redirection unit is capable of modifying the URL comprising the subsequent web page request to refer to a password web page stored on a designated server and also directing the subsequent web page request to the designated server if the source address of the subsequent web page request does not equal the source address stored in the current user identifier variable; and
wherein the access manager is capable of receiving a password override signal and stores the source address of the subsequent web page request in the current user identifier variable if the password override signal is received.

23. A customer premises equipment (CPE) access device comprising:
local area network interface;
wide area network interface; and
access manager that is capable of:
receiving a maximum user count;
receiving a web page request from the local area network interface;
extracting a source address from said web page request;
creating a new user record if the extracted source address can not be found in an existing user record and the number of existing records is less than the maximum user count;
directing the web page request to a designated server if the extracted source address can not be found in an existing user record and the number of user records is equal to the maximum user count; and
directing the web page request to the wide area network interface if the extracted source address can be found in an existing user record.

24. The CPE access device of claim 23 wherein the access manager further comprises:
redirection unit that is capable of modifying the URL of the web page request to refer to a web page stored on a designated server if the extracted source address can not be found in an existing user record and the number of user records is equal to the maximum user count.
